(19) United States
(12) Patent Application Publication
(10) Pub. No.: US 2025/0150214 A1
(43) Pub. Date: May 8, 2025

(54) LOSSLESS COMPRESSION FOR HARQ-ACK CODEBOOKS WITH DIFFERENT BLER

(71) Applicant: QUALCOMM Incorporated, San Diego, CA (US)

(72) Inventors: Yi HUANG, San Diego, CA (US); Mostafa KHOSHNEVISAN, San Diego, CA (US); Jing SUN, San Diego, CA (US)

(21) Appl. No.: 18/503,745

(22) Filed: Nov. 7, 2023

(51) Int. Cl. H04L 1/1829

(52) U.S. Cl. CPC H04L 1/1861; H04L 1/1854

(57) ABSTRACT

Lossless compression for HARQ-ACK codebooks with different BLER is described. An apparatus is configured to receive downlink transmission(s) from a network node. The apparatus is configured to transmit two-part HARQ-ACK feedback for the downlink transmission(s) based on: a first compression data set for a first HARQ-ACK codebook and a second compression data set for a second HARQ-ACK codebook, and/or a third compression data set based on a combination of the first and second HARQ-ACK codebooks. Another apparatus is configured to configure a UE with a first configuration for a first compression data set, a second compression data set, or a third compression data set, or a second configuration for a first rate, a second rate, or a third rate. The apparatus is configured to receive two-part HARQ-ACK feedback for a downlink transmission(s) based on the first and second compression data sets or the third compression data set.

### TECHNICAL FIELD

The present disclosure relates generally to communication systems, and more particularly, to wireless communications utilizing hybrid automatic repeat request (HARQ) acknowledgement (HARQ-ACK) mechanisms.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise a user equipment (UE), and the method may be performed at/by a UE. The apparatus is configured to receive one or more downlink transmissions from a network node. The apparatus is also configured to transmit two-part HARQ-ACK feedback for the one or more downlink transmissions based on at least one of: a first compression data set for a first HARQ-ACK codebook and a second compression data set for a second HARQ-ACK codebook, or a third compression data set based on a combination of the first HARQ-ACK codebook and the second HARQ-ACK codebook.

In the aspect, the method includes receiving one or more downlink transmissions from a network node. The method also includes transmitting two-part HARQ-ACK feedback for the one or more downlink transmissions based on at least one of: a first compression data set for a first HARQ-ACK codebook and a second compression data set for a second HARQ-ACK codebook, or a third compression data set based on a combination of the first HARQ-ACK codebook and the HARQ second HARQ-ACK codebook.

In an aspect of the disclosure, a method, a computer-readable medium, and an apparatus are provided. The apparatus is configured to configure a UE with at least one of (i) a first configuration indicative of at least one of a first compression data set, a second compression data set, or a third compression data set, or (ii) a second configuration indicative of at least one of a first rate, a second rate, or a third rate. The apparatus is also configured to receive, from the UE, two-part HARQ-ACK feedback for one or more downlink transmissions based on at least one of: the first compression data set for a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook.

In the aspect, the method includes configuring a UE with at least one of (i) a first configuration indicative of at least one of a first compression data set, a second compression data set, or a third compression data set, or (ii) a second configuration indicative of at least one of a first rate, a second rate, or a third rate. The method also includes receiving, from the UE, two-part HARQ-ACK feedback for one or more downlink transmissions based on at least one of: the first compression data set for a first HARQ-ACK codebook and the second compression data set for a second HARQ-ACK codebook, or the third compression data set based on a combination of the first HARQ-ACK codebook and the second HARQ-ACK codebook.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a two-part HARQ-ACK.

FIG. 5 is a diagram illustrating an example data set of a two-part HARQ-ACK.

FIG. 6 is a diagram illustrating an example of codebooks with different block error rate (BLER).

FIG. 7 is a call flow diagram for wireless communications, in accordance with various aspects of the present disclosure.

FIG. 8 is a diagram illustrating examples separate- and joint-compression of codebooks with different BLER, in accordance with various aspects of the present disclosure.

FIG. 9 is a diagram illustrating an example data set construction for joint compression of codebooks with different BLER, in accordance with various aspects of the present disclosure.

FIG. 10 is a diagram illustrating example data sets for joint compression of codebooks with different BLER, in accordance with various aspects of the present disclosure.

FIG. 11 is a diagram illustrating examples of multiplexing using compression of codebooks with different BLER, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

Wireless communication networks may be designed to support communications between network nodes (e.g., base stations, gNBs, etc.) and UEs. For instance, a network node may transmit a downlink transmission to a UE and receive a HARQ-ACK from the UE indicating whether the UE accurately received the downlink transmission. A HARQ-ACK that includes N bits may have 2^{N} codepoints that are not equally likely to occur. This may be due to a BLER target that is less than or equal to 10% (e.g., 0.1), but also may be due to correlations in time, frequency, and/or layers (e.g., across slots, code block groups (CBGs), component carriers (CCs), transport blocks (TBs), etc.). To minimize HARQ-ACK payloads, compression may be implemented. As an example, the UE may send a two-part HARQ-ACK that enables compression mechanisms, where the two parts are separately encoded. The first part may have a fixed size, and may carry information that indicates a size of the second part. This enables the second part to have a variable size, while enabling the base station to decode both parts in an efficient manner. The network node decodes the first part before the second part, and the size and interpretation of the second part depends on the indicated codepoint of the first part. Thus, two-part HARQ-ACKs may achieve close to optimal compression in terms of average HARQ-ACK payload length.

Aspects presented herein further enable two-part HARQ-ACK based on two HARQ-ACK codebooks that are designed with different BLER targets. Aspects presented herein provide solutions for optimizing compression of the codebooks. Additionally, aspects presented herein provide solutions for encoding the compressed codebooks of two HARQ-ACKs with different BLER targets. As one example, the aspects presented herein may be used to handle different (sub) codebooks of HARQ-ACKs for TB-based PDSCH (e.g., for a primary cell (PCell)) and CBG-based PDSCH (e.g., for a secondary cell (SCell)). As another example, the aspects presented herein may be used to handle both high priority and low priority HARQ-ACK codebooks for a PDSCH.

Various aspects relate generally to two-part HARQ-ACKs. Some aspects more specifically relate to lossless compression for HARQ-ACK based on multiple HARQ-ACK codebooks with different BLER. In some examples, HARQ-ACK compression for HARQ-ACK codebooks with different BLER may be optimized for separate compression of the codebooks, or compression for HARQ-ACK codebooks with different BLER may be optimized for joint compression of the codebooks. In some examples, compression for HARQ-ACK codebooks with different BLER may be optimized for a combination of separate/joint compression of the codebooks. In some examples, compression for HARQ-ACK codebooks with different BLER optimized using joint compression may further utilize a joint data set that is based on two data sets for single codebook compression of two different HARQ-ACKs, respectively. In some examples, compression for HARQ-ACK codebooks with different BLER may be utilized in uplink control information (UCI) multiplexing.

Particular aspects of the subject matter described in this disclosure can be implemented to realize one or more of the following potential advantages. In some examples, by minimizing codebooks in partitioned data sets utilized for compression of HARQ-ACK codebooks with different BLER based on occurrence likelihoods, correlated with low bit lengths, the described techniques can be used to reduce HARQ-ACK payload size in terms of average payload lengths. In some examples, by providing compression flexibility using separate- and/or joint-compression, the described techniques can be used to efficiently handle codebooks with different BLER targets across TB/CBG PDSCHs (e.g., of different cells) as well as high/low priority HARQ-ACK codebooks with different BLER (e.g., in a single cell).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

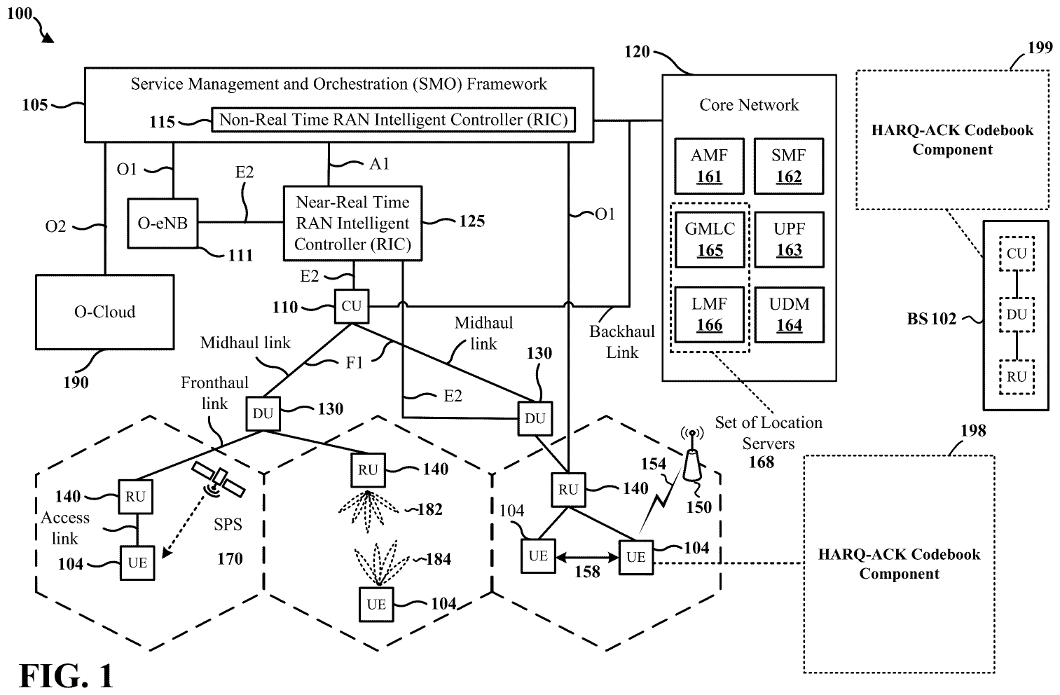

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a HARQ-ACK codebook component 198 (“component 198”) that may be configured to receive one or more downlink transmissions from a network node. The component 198 may also be configured to transmit two-part HARQ-ACK feedback for the one or more downlink transmissions based on at least one of: a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. The component 198 may be configured to receive, from the network node, a first configuration indicative of at least one of the first compression data set, the second compression data set, or the third compression data set. The component 198 may be configured to encode, as a payload for the two-part HARQ-ACK feedback and for an associated channel, at least one of a first part of a first compressed codebook, the first part of a second compressed codebook, a second part of the first compressed codebook, or the second part of the second compressed codebook. The component 198 may be configured to encode, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set. In certain aspects, the base station 102 may have a HARQ-ACK codebook component 199 (“component 199”) that may be configured to configure a UE with at least one of (i) a first configuration indicative of at least one of a first compression data set, a second compression data set, or a third compression data set, or (ii) a second configuration indicative of at least one of a first rate, a second rate, or a third rate. The component 199 may also be configured to receive, from the UE, two-part HARQ-ACK feedback for one or more downlink transmissions based on at least one of: the first compression data set based on a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook. The component 199 may be configured to decode a payload of the two-part HARQ-ACK feedback based on at least one of the first configuration or the second configuration. Accordingly, aspects herein provide for separate and/or joint-compression of HARQ-ACK codebooks with different BLER. Aspects reduce HARQ-ACK payload size in terms of average payload lengths by minimizing codebooks in partitioned data sets utilized for compression of HARQ-ACK codebooks with different BLER based on occurrence likelihoods correlated with low bit lengths. Aspects also enable efficient handling of codebooks with different BLER targets across TB/CBG PDSCHs, as well as high/low priority HARQ-ACK codebooks with different BLER by providing compression flexibility using separate- and/or joint-compression.

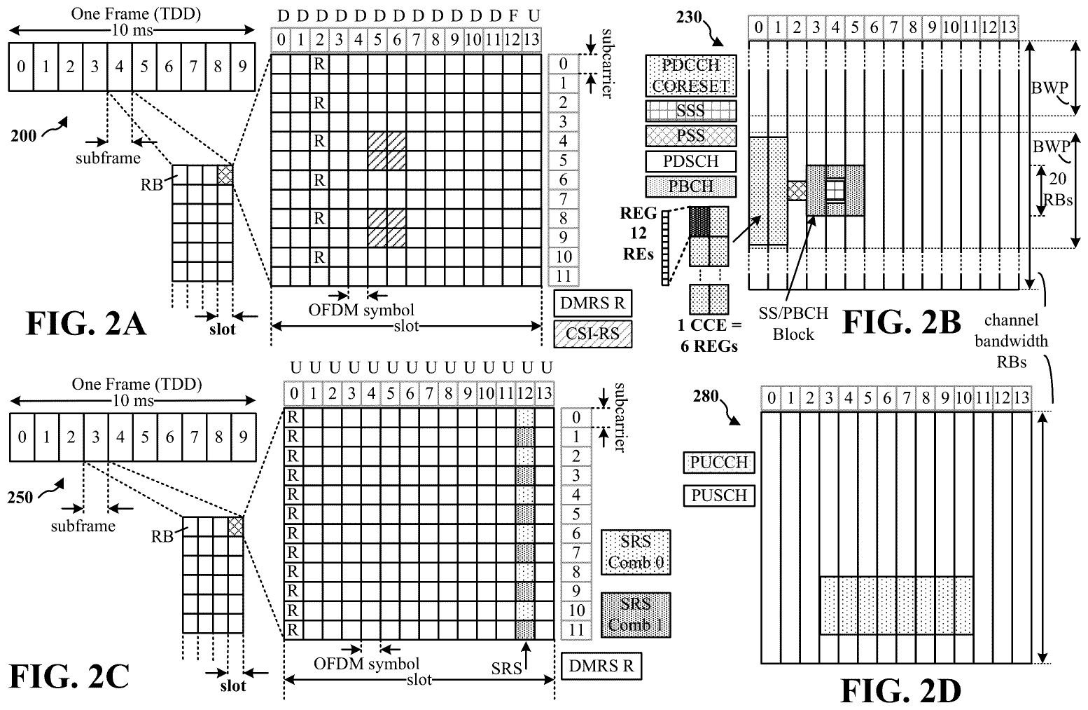

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

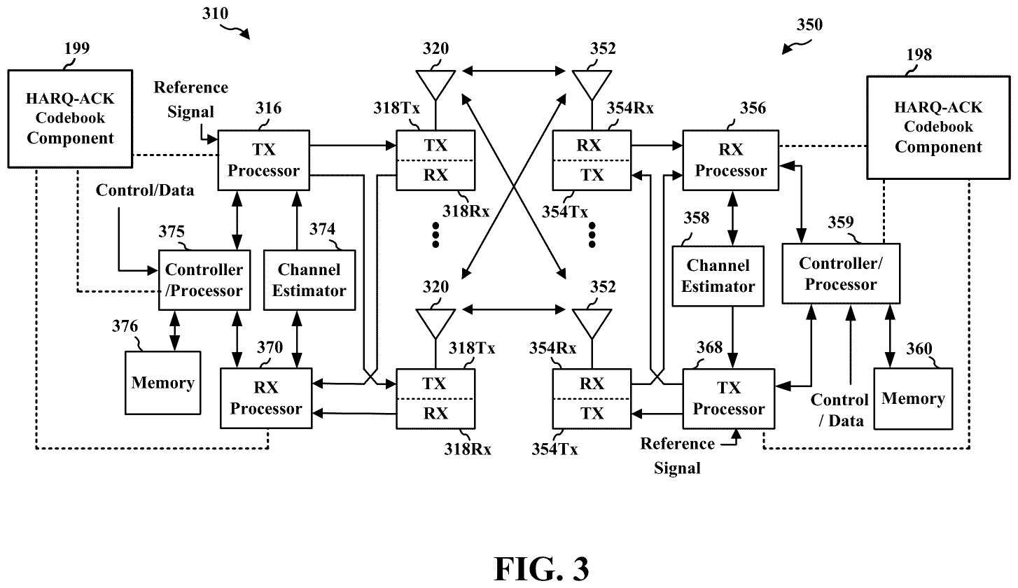

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions, Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A network node, such as 310, may transmit one or more downlink transmissions to a UE 350. The UE 350 responds by transmitting a HARQ-ACK to the network node indicating whether the UE accurately received the downlink transmission(s). A HARQ-ACK that includes N bits may have 2^{N} codepoint options. The different codepoints may not be equally likely to occur, e.g., based on a BLER target, correlations in time, frequency, and/or layers (e.g., across slots, code block groups (CBGs), component carriers (CCs), transport blocks (TBs), etc.). To minimize HARQ-ACK payloads, the UE may use compression. As noted above, a two-part HARQ-ACK may enable compression of the HARQ-ACK payload. The two parts of the HARQ-ACK may be separately encoded. As it is easier for the network to decode a message having a fixed size, the first part of the HARQ-ACK may indicate a size of the second part of the HARQ-ACK. The first part may have a fixed size, enabling the network node to use the known size to receive the first part. Once the first part is received, the network node can obtain the size information for the second part of the HARQ-ACK and use the size information to further receive the second part of the HARQ-ACK. This enables the second part of the HARQ-ACK to have a variable size while maintaining a lower complexity for the network node to receive the HARQ-ACK, because the network node knows the size of the HARQ-ACK parts before attempting to receive them. For example, the network node decodes the first part before the second part, and the size and interpretation of the second part depends on the indicated codepoint of the first part. Thus, two-part HARQ-ACKs may achieve close to optimal compression in terms of average HARQ-ACK payload length.

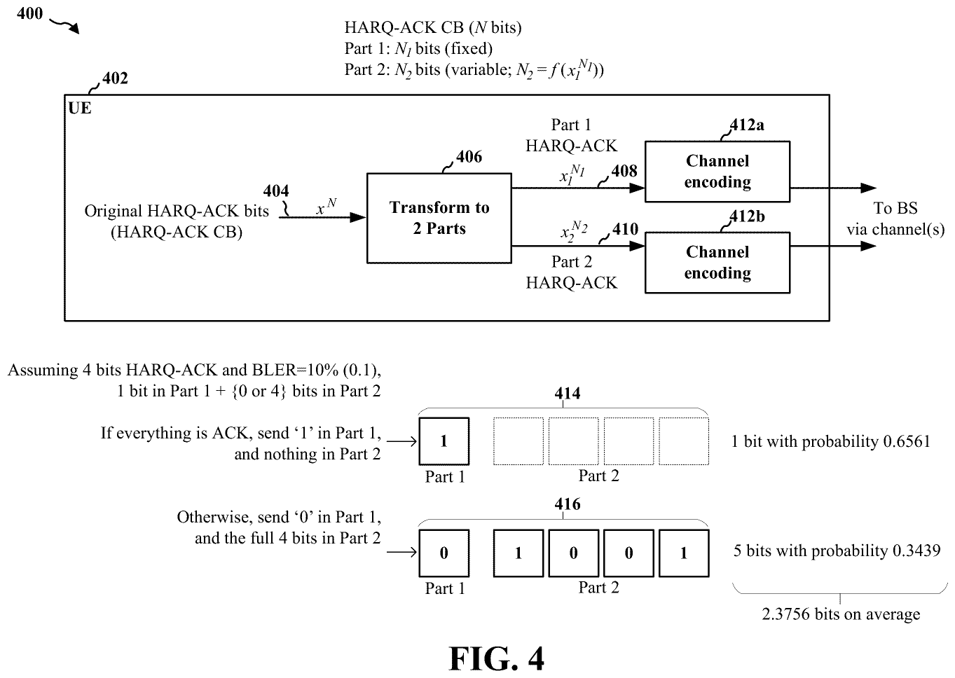

FIG. 4 is a diagram 400 illustrating an example of HARQ-ACK compression based on a two-part HARQ-ACK. The diagram 400 shows an example UE 402 in the context of generation and transmission for a HARQ-ACK payload, which may be a two-part HARQ-ACK codebook (or CB), having N bits. Part 1 of HARQ-ACK is based on a part of the codebook that includes N₁ bits (fixed for a given N, e.g., not a function of the number of bits x^{N} of the HARQ-ACK codebook 404), while part 2 of the HARQ-ACK is based on a second part of the codebook that includes N₂ bits, which may be variable and a function of x″ (e.g., a variable length that depends on the length of the part 1 N₁ bits.

As shown, the UE 402 may generate the number of bits x^{N} of the HARQ-ACK codebook 404, and then transform (at 406) the number of bits x^{N} of the HARQ-ACK codebook 404 into the two parts: a part 1 HARQ-ACK 408 x₁^{N}^{₁} (having a fixed size) and a part 2 HARQ-ACK 410 x₂^{N}^{₂} (having a variable size). The UE 402 performs channel encoding (at 412a) for the part 1 HARQ-ACK 408 x₁^{N}^{₁} and performs channel encoding (at 412b) for the part 2 HARQ-ACK 410 x₂^{N}^{₂}. The channel encoded representations of part 1 HARQ-ACK 408 x₁^{N}^{₁} and a part 2 HARQ-ACK 410 x₂^{N}^{₂} are provided/transmitted via a channel(s) to a network node. Upon reception, the network node (e.g., a base station/gNB) may first decode part 1 of the HARQ-ACK based on the codebook, then determine the length of the part 2 of the HARQ-ACK based on the codebook. The network node may decode the part 2 of the HARQ-ACK based on the codebook and determine the original HARQ-ACK feedback corresponding to the x^{N} bits.

As an illustrative example, diagram 400 shows a HARQ-ACK 414 (4-bit) and a HARQ-ACK 416 (4-bit). Assuming the 4-bit HARQ-ACKs shown and a BLER=10% (e.g., 0.1), a two-part HARQ-ACK may be configured as having 1 bit in Part 1 +{0 or 4} bits in Part 2. If each of the bits of the HARQ-ACK are associated with an ACK, the UE 402 may send to the network node a ‘1’ in part 1, and nothing in part 2, as shown for the HARQ-ACK 414 (e.g., indicative of 1 bit with a probability of 0.6561). Otherwise, the UE 402 may send to the network node a ‘0’ in part 1, and 4 bits in part 2, as shown by way of example for the HARQ-ACK 416 (e.g., indicative of 5 bits with a probability of 0.3439). This may indicate an average of a 2.3756 bit length. It should be noted that probabilities shown in the FIGs. herein are for illustration and descriptive purposes; a base station, gNB, etc., may or may not include such probabilities in various data sets/information that is/are provided to a UE, in aspects.

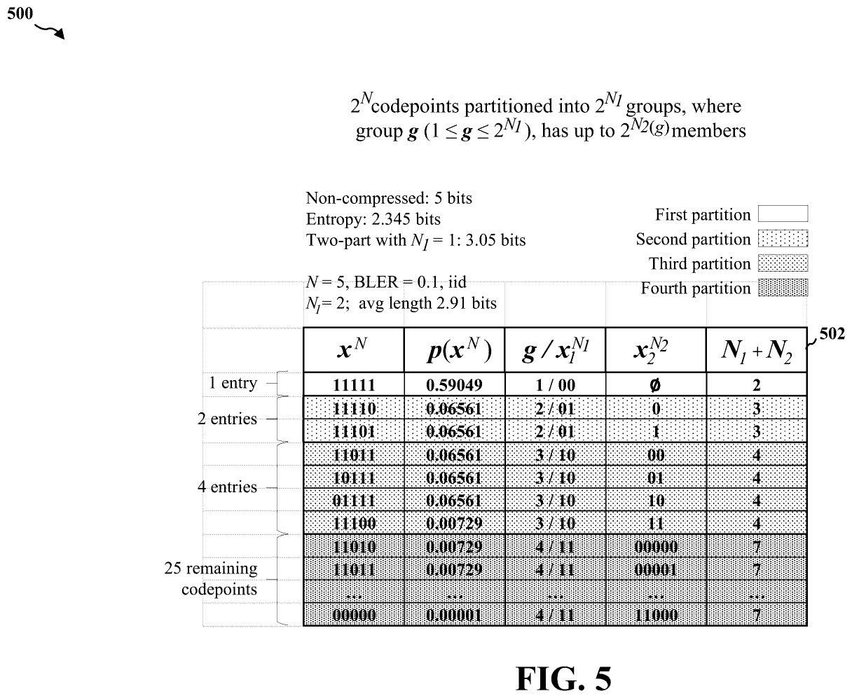

FIG. 5 is a diagram 500 illustrating an example data set of a two-part HARQ-ACK. Diagram 500 shows that the data set 502 may be partitioned for use with a two-part HARQ-ACK. The data set 502 represents, by way of example, a non-compressed 5-bit HARQ-ACK codebook, where entropy is 2.345 bits and a corresponding standard, two-part coding would have N₁=3.05 bits on average. In the illustrated example of the data set 502, N=5, the BLER=0.1 (iid), and the N₁=2, which results in an average length of 2.91 bits for the codebook payload via compression.

The data set 502 includes 2^{N} codepoints and is partitioned into 2^{N}^{₁} groups, where group g (1≤g≤2^{N}^{₁}) has up to 2^{N}^{₂}^{(g)} members. The data set 502 includes four partitions, by way of example. Generally, to minimize N₁+Σₓ_{^{N}} p(x^{N})N₂(x^{N}) and reduce the codebook payload, a smaller N₁ may be utilized when some codepoints of x^{N} are much more likely, allowing for an exhaustive search (e.g., for N=1 or N=2). However, such minimization may have a non-deterministic polynomial-time hardness. Aspects herein enable the possibility to exhaustively search for N₁=1 or N₁=2. For N₁=1, a partition may be represented as {all ACK, all other 2^{N}−1 codepoints} for all scenarios. In some configurations, however, N₁=2 can be better than N₁=1, as illustrated by the data set 502. Such optimization/partitioning may be performed, in aspects, by a network node, and may be dependent on one or more factures such as scheduling strategy, target BLER, correlation, estimated protected management frames (PMFs), etc. In these configurations, the UE may be provided with the partitions (which may be a function of N as well). For example, the network may signal, or transmit an indication of, the partitions to the UE.

When two HARQ-ACK codebooks are designed with different BLER targets, issues may arise for optimizing compression of the codebooks.

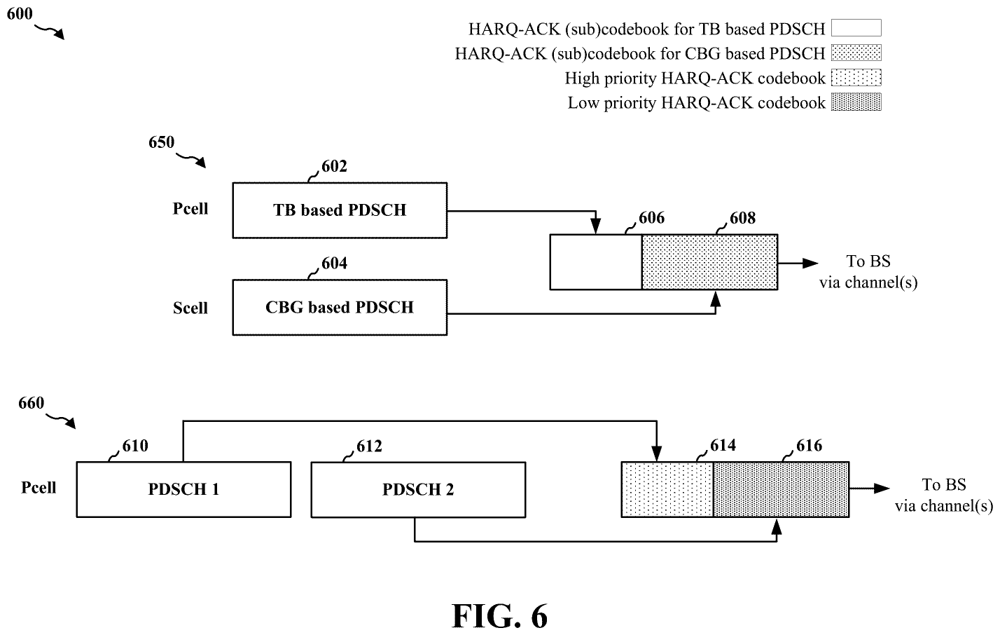

FIG. 6 is a diagram 600 illustrating examples of two part HARQ-ACK based on codebooks with different BLERs. Diagram 600 shows a configuration 650 for compression associated with CBG based HARQ-ACK feedback and TB based HARQ-ACK feedback, as well as a configuration 660 for compression associated with high priority and low priority HARQ-ACK feedback. For example, the TB based feedback may be based on a first HARQ-ACK codebook associated with a first BLER, and the CBG feedback may be based on a different codebook associated with a different BLER. Similarly, the high priority feedback may be based on a first HARQ-ACK codebook associated with a first BLER, and the lower priority feedback may be based on a different codebook associated with a different BLER. These two use cases are merely examples to illustrate the concept of HARQ-ACK feedback based on multiple codebooks having different BLERs, and the concepts presented herein may be used for other examples.

In configuration 650, the network node transmits a TB based PDSCH 602 to the UE from a PCell, and the UE has HARQ-ACK feedback to indicate whether the TB was accurate received, the feedback based on a HARQ-ACK (sub) codebook 606. The network may also transmit a CBG based PDSCH 604 to the UE, e.g., from an SCell, and the UE may have HARQ-ACK feedback for the CBG based PDSCH 604. The CBG based HARQ-ACK feedback is based on a HARQ-ACK (sub) codebook 608. As a network node may target different BLER for TB and CBG PDSCHs, aspects herein provide techniques to compress the two (sub) codebooks (e.g., the HARQ-ACK (sub) codebook 606 and the HARQ-ACK (sub) codebook 608) having different target BLERs. In configuration 660, the network node may transmit a first PDSCH 610 from a PCell to the UE. The PDSCH may have a high priority, and the UE may generate HARQ-ACK feedback based on a high priority HARQ-ACK codebook 614. The network node may also transmit a second PDSCH 612 to the UE, which may be from the PCell. The second PDSCH may have a lower priority, and the UE may generate the corresponding HARQ-ACK using a low priority HARQ-ACK codebook 616. As PDSCHs associated with higher priority/lower priority HARQ-ACKs may have different BLER targets, aspects herein provide techniques to compress the two codebooks (e.g., the high priority HARQ-ACK codebook 614 and the low priority HARQ-ACK codebook 616). Such aspects are described in further detail herein in the context of the following FIGs.

For instance, aspects herein for lossless compression for HARQ-ACK codebooks with different BLER provide compression for such HARQ-ACK codebooks with different BLER that may be optimized for separate compression of the codebooks, or compression for HARQ-ACK codebooks with different BLER may be optimized for joint compression of the codebooks. Compression for HARQ-ACK codebooks with different BLER may also be optimized for a combination of separate/joint compression of the codebooks. In some aspects, compression for HARQ-ACK codebooks with different BLER may be optimized using joint compression with a joint data set that is based on two data sets for single codebook compression of two different HARQ-ACKs, respectively. Aspects reduce HARQ-ACK payload size in terms of average payload lengths by minimizing codebooks in partitioned data sets utilized for compression of HARQ-ACK codebooks with different BLER based on occurrence likelihoods correlated with low bit lengths. Aspects also enable efficient handling of codebooks with different BLER targets across TB/CBG PDSCHs, as well as high/low priority HARQ-ACK codebooks with different BLER by providing compression flexibility using separate- and/or joint-compression.

Aspects herein utilize mechanisms for two-part HARQ-ACKs to achieve close to optimal compression in terms of average HARQ-ACK codebook payload length resulting in improved overhead reduction (or compression gain), which provides improvements and increased efficiencies for devices in wireless communication systems for 5G NR and beyond (e.g., in 6G systems, etc.). The aspects herein provide lossless compression schemes to compress two HARQ-ACK codebooks with different BLER targets. The key observation is that, when two HARQ-ACK codebooks are designed with different BLER targets (e.g., on the corresponding DL data), the two HARQ-ACK codebooks can be compressed with different rates. The aspects herein provide for both joint compression and separate compression, and are also applicable to other relevant problems in wireless communication systems (e.g., UCI multiplexing on PUSCH/PUCCH procedures).

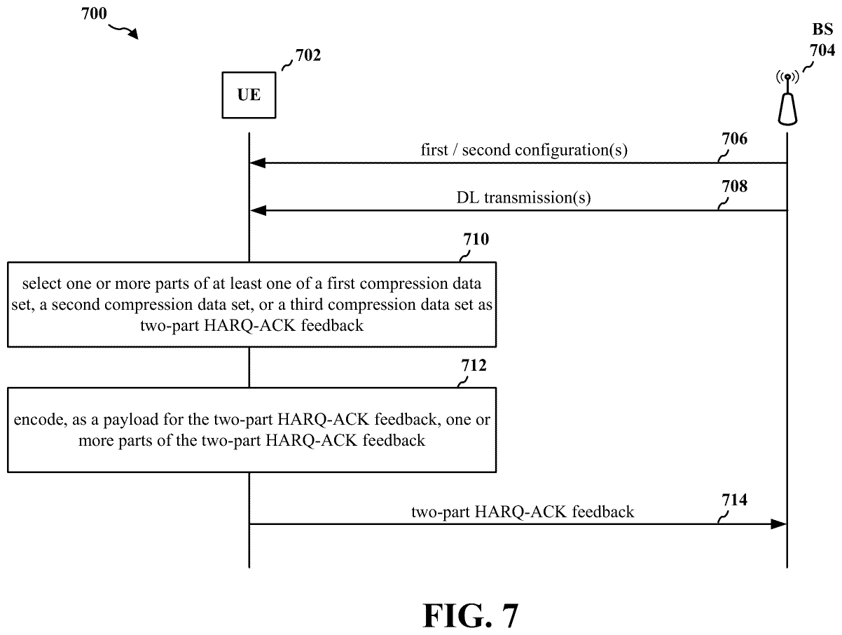

FIG. 7 is a call flow diagram 700 for wireless communications, in various aspects. Call flow diagram 700 illustrates lossless compression for HARQ-ACK codebooks with different BLER for a wireless device (a UE 702, by way of example) that communicates with the network node (a base station 704, such as a gNB or other type of base station, by way of example, as shown), in various aspects. Aspects described for the base station 704 may be performed by the base station in aggregated form and/or by one or more components of the base station in disaggregated form. Additionally, or alternatively, the aspects may be performed by the UE 702 autonomously, in addition to, and/or in lieu of, operations of the base station 704.

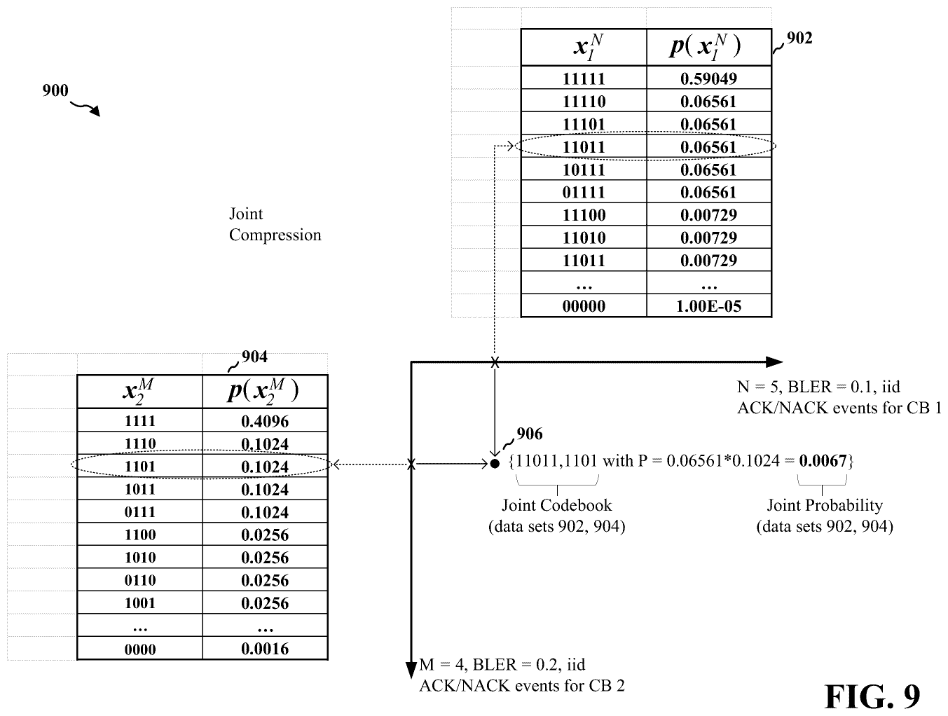

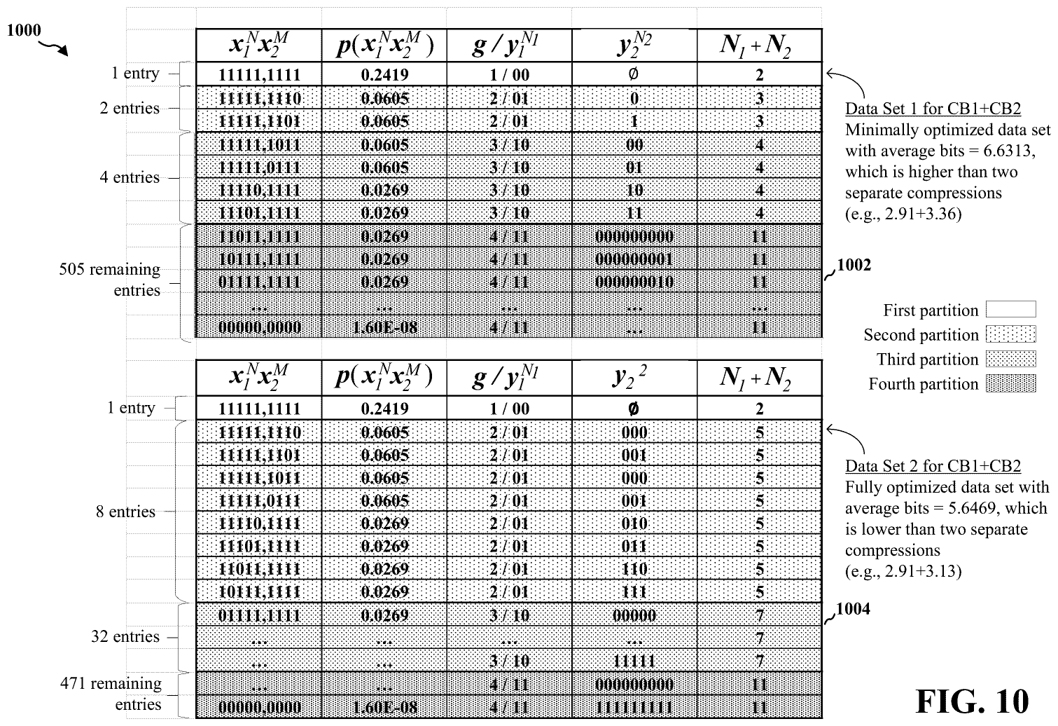

In the illustrated aspect, the UE 702 may be configured to receive, and the base station 704 may be configured to transmit/provide, a first and/or a second configuration 706. In aspects, the first configuration of the first and/or the second configuration 706 may be indicative of at least one of a first compression data set, a second compression data set, or a third compression data set. The first compression data set may be a data set associated with compression for a first HARQ-ACK codebook of a first HARQ-ACK, the second compression data set may be a data set associated with compression for a second HARQ-ACK codebook of a second HARQ-ACK, and the third compression data set may be a data set associated with joint compression for the first HARQ-ACK codebook of the first HARQ-ACK and the second HARQ-ACK codebook of the second HARQ-ACK. The first compression data set, the second compression data set, and/or the third compression data set may be a partitioned data set that includes a first number of N-bit codepoint values, e.g., as described above for FIG. 5 and below for FIGS. 9, 10. As described herein, a data set may be a set of data in which an element ‘A’ is associated with an element ‘B’, and a given data set may be configured and/or implemented in different ways according to various data structures. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. In aspects, the second configuration of the first and/or the second configuration 706 may be indicative of at least one of a first rate, a second rate, or a third rate. The first rate, the second rate, and the third rate may be BLERs associated with the first compression data set, the second compression data set, and the third compression data set, respectively.

The UE 702 may be configured to receive, and the base station 704 may be configured to transmit/provide, one or more DL transmissions 708. In some aspects, the UE 702 may be configured to receive, and the base station 704 and/or another base station (not shown for illustrative clarity and brevity) may be configured to transmit/provide, the one or more DL transmissions 708. That is, the one or more DL transmissions 708 may be included in a PDSCH(s) from the base station 704 (e.g., a PCell), or may be included in PDSCHs from the base station 704 (e.g., a PCell) and another base station (e.g., an SCell). The one or more DL transmissions 708 may include a first PDSCH that corresponds to the first HARQ-ACK codebook of a HARQ-ACK and a second PDSCH that corresponds to the second HARQ-ACK codebook of a HARQ-ACK. In aspects, the one or more DL transmissions 708 may include data/information for which the UE 702 generates a HARQ-ACK codebook(s) as feedback.

The UE 702 may be configured to generate, based on the one or more DL transmissions 708 from the base station 704, at least one of: a first HARQ-ACK codebook associated with a HARQ-ACK and a first compression data set, a second HARQ-ACK codebook associated with the HARQ-ACK and a second compression data set, or a third codebook associated with the HARQ-ACK and a third compression data set. That is, HARQ-ACK codebooks may be generated by the UE 702 to indicate ACKs and/or NACKs for the one or more DL transmissions 708.

The UE 702 may be configured to select (at 710) one or more parts of at least one of a first compression data set, a second compression data set, or a third compression data set as two-part HARQ-ACK feedback. The UE 702 may be configured to select (at 710) a first compressed codebook and a second compressed codebook for at least one of a separate compression or a joint compression for the first and the second HARQ-ACK codebooks. The separate compression may include two-part HARQ-ACK feedback, and may include a first part indicating a first group within the first compression data set that partitions the first HARQ-ACK codebook into a first set of multiple groups and a second part indicating a first codepoint of the first HARQ-ACK codebook within the first group indicated in the first part, and a third part indicating a second group within the second compression data set that partitions the second HARQ-ACK codebook into a second set of multiple groups and a fourth part indicating a second codepoint of the second HARQ-ACK codebook within the second group indicated in the third part. The joint compression may be associated with two-part HARQ-ACK feedback that includes jointly compressed feedback based on the third compression data set. The two-part HARQ-ACK feedback may include a first part indicating a group within the third compression data set that partitions the combination of the first HARQ-ACK codebook and the second HARQ-ACK codebook into multiple groups, and a second part indicating a first codepoint of the first HARQ-ACK codebook and a second codepoint of the second HARQ-ACK codebook based on the group within the third compression data set that is indicated in the first part. In aspects, the two-part HARQ-ACK feedback may include first parts of both the first HARQ-ACK codebook and the second HARQ-ACK codebook based on a third rate based on the third compression data set, and second parts of both the first HARQ-ACK codebook and the second HARQ-ACK codebook based on the third rate.

The UE 702 may be configured to encode (at 712), as the payload for the two-part HARQ-ACK feedback 714, and for at least one associated channel in aspects, one or more parts of the two-part HARQ-ACK feedback. For instance, the UE 702 may be configured to encode (at 712) at least one of a first part of a first compressed codebook, the first part of a second compressed codebook, a second part of the first compressed codebook, or the second part of the second compressed codebook. As one example, the UE 702 may be configured to encode (at 712), separately, each of the first part of the first compressed codebook, the first part of the second compressed codebook, the second part of the first compressed codebook, and the second part of the second compressed codebook. As another example, the UE 702 may be configured to encode (at 712), jointly, first parts of both a first compressed codebook and a second compressed codebook based on the third compression data set, and second parts of both the first HARQ-ACK codebook and the second HARQ-ACK codebook based on the third compression data set. As still another example, the UE 702 may be configured to encode (at 712), separately and jointly, ones of the first part of the first compressed codebook, the first part of the second compressed codebook, the second part of the first compressed codebook, and the second part of the second compressed codebook.

The UE 702 may be configured to transmit/provide, and the base station 704 may be configured to receive, two-part HARQ-ACK feedback 714 for the one or more downlink transmissions. The two-part HARQ-ACK feedback 714 may include a HARQ-ACK payload (e.g., a payload representing the compressed parts of the HARQ-ACK codebooks selected (at 710) by the UE 702). The two-part HARQ-ACK feedback 714 based on at least one of a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. The two-part HARQ-ACK feedback 714 may include two-part HARQ-ACK feedback, as described above, and may include a first compressed codebook and a second compressed codebook selected (at 710) by the UE 702 that represent a first part indicating a first group within the first compression data set that partitions the first HARQ-ACK codebook into a first set of multiple groups and a second part indicating a first codepoint of the first HARQ-ACK codebook within the first group indicated in the first part, and a third part indicating a second group within the second compression data set that partitions the second HARQ-ACK codebook into a second set of multiple groups and a fourth part indicating a second codepoint of the second HARQ-ACK codebook within the second group indicated in the third part for separate compression and/or that represent a first part indicating a group within the third compression data set that partitions the combination of the first HARQ-ACK codebook and the second HARQ-ACK codebook into multiple groups, and a second part indicating a first codepoint of the first HARQ-ACK codebook and a second codepoint of the second HARQ-ACK codebook based on the group within the third compression data set that is indicated in the first part for joint compression.

The base station 704 may be configured to subsequently decode the payload of the two-part HARQ-ACK feedback 714 based on at least one of the first configuration or the second configuration (e.g., the first and/or the second configuration 706).

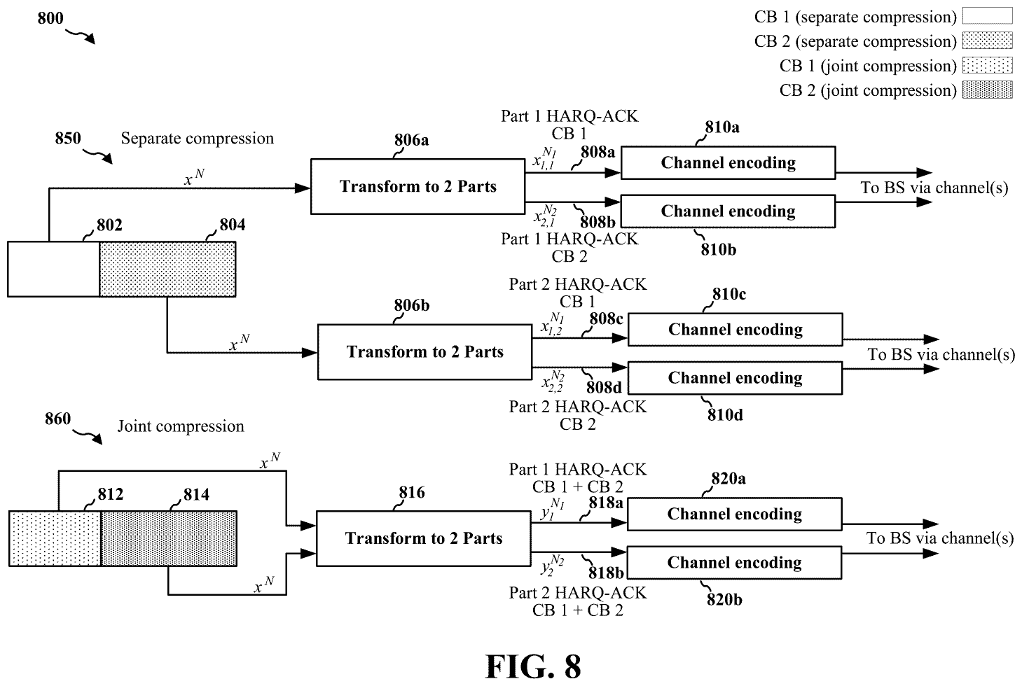

FIG. 8 is a diagram 800 illustrating examples separate- and joint-compression of codebooks with different BLER, in various aspects. The diagram 800 shows a configuration 850 for separate compression of two HARQ-ACK codebooks (or CBs) with different BLER, and shows a configuration 860 for joint compression of two HARQ-ACK codebooks with different BLER targets. In aspects, the illustrated configurations may be associated with performance of lossless compression for HARQ-ACK codebooks with different BLER by a UE.

The configuration 850 for separate compression of codebooks includes a first HARQ-ACK codebook 802 with a first BLER target associated with a network node and a second HARQ-ACK codebook 804 with a different second BLER target associated with a network node generated by a UE. In aspects, the first HARQ-ACK codebook 802 may be associated with a TB based PDSCH and the second HARQ-ACK codebook 804 may be associated with a CBG based PDSCH. For separate compression in the configuration 850, the first HARQ-ACK codebook 802 is provided for transformation to two parts (at 806a), while the second HARQ-ACK codebook 804 is provided for transformation to two parts (at 806b).

The transformation to two parts (at 806a) for the first HARQ-ACK codebook 802 may be based on a first compression data set associated with the first HARQ-ACK codebook 802, as described herein. The transformation to two part (at 806a) for the first HARQ-ACK codebook 802 may include generating/determining a first part 808a and a second part 808b of the first HARQ-ACK codebook 802 as a compressed representation thereof. For example, the first HARQ-ACK codebook 802 having x^{N} bits may be transformed into the first part 808a (x_{1,1}^{N}^{₁} bits) and the second part 808b (x_{2.1}^{N}^{₂} bits) associated with the first compression data set for the first HARQ-ACK codebook 802. The first part 808a (x_{1,1}^{N}^{₁} bits) and the second part 808b (x_{2,1}^{N}^{₂} bits) may then be channel encoded (at 810a and 810b, respectively) for provision/transmission to a network node, e.g., a base station, gNB, etc.

Likewise, the transformation to two part (at 806b) for the second HARQ-ACK codebook 804 may be based on a second compression data set associated with the second HARQ-ACK codebook 804, as described herein. The transformation to two part (at 806b) for the second HARQ-ACK codebook 804 may include generating/determining a first part 808c and a second part 808d of the second HARQ-ACK codebook 804 as a compressed representation thereof. For example, the second HARQ-ACK codebook 804 having x^{N} bits may be transformed into the first part 808c (x_{1,2}^{N}^{₁} bits) and the second part 808d (x_{2,2}^{N}^{₂} bits) associated with the second compression data set for the second HARQ-ACK codebook 804. The first part 808c (x_{1,2}^{N}^{₁} bits) and the second part 808d (x_{2,2}^{N}^{₂} bits) may then be channel encoded (at 810c and 810d, respectively) for provision/transmission to a network node, e.g., a base station, gNB, etc.

The configuration 860 for joint compression of codebooks includes a first HARQ-ACK codebook 812 with a first BLER target associated with a network node and a second HARQ-ACK codebook 814 with a different second BLER target associated with a network node generated by a UE. In aspects, the first HARQ-ACK codebook 812 may be associated with a high priority and the second HARQ-ACK codebook 814 may be associated with a low priority. For joint compression in the configuration 860, the first HARQ-ACK codebook 812 and the second HARQ-ACK codebook 804 are provided together for transformation to two part (at 816).

The transformation to two part (at 816) for the first HARQ-ACK codebook 812 and the second HARQ-ACK codebook 814 may be based on a third compression data set for joint compression that is based on a first compression data set associated with the first HARQ-ACK codebook 812 and a second compression data set associated with the second HARQ-ACK codebook 814, as described herein. The transformation to two parts (at 816) for the first HARQ-ACK codebook 812 and the second HARQ-ACK codebook 814 may include generating/determining a first part 818a and a second part 818b of the first HARQ-ACK codebook 812 together with the second HARQ-ACK codebook 814 as a compressed representation thereof. For example, the first HARQ-ACK codebook 812 and the second HARQ-ACK codebook 814, each having x^{N} bits, may be transformed into the first part 818a (y₁^{N}^{₁} bits) and the second part 818b (y₂^{N}^{₂} bits) associated with the third compression data set for joint compression of the HARQ-ACK codebooks. The first part 818a (y₁^{N}^{₁} bits) and the second part 818b (y₂^{N}^{₂} bits) may then be channel encoded (at 820a and 820b, respectively) for provision/transmission to a network node, e.g., a base station, gNB, etc.

FIG. 9 is a diagram 900 illustrating an example data set construction for joint compression of codebooks with different BLER, in various aspects. The diagram 900 shows a first compression data set 902, which may be associated with a first HARQ-ACK codebook and corresponding BLER, and a second compression data set 904, which may be associated with a second HARQ-ACK codebook and corresponding BLER that is different from the BLER corresponding to the first HARQ-ACK codebook.

As noted herein, a first compression data set, a second compression data set, and/or a third compression data set, as described, may be a partitioned data set that includes a first number of N-bit codepoint values. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. For a third compression data set, as described herein, which may be based on a first compression data set and a second compression data set for separate HARQ-ACK codebooks. For instance, given a BLER of P1 (e.g., the NACK probability) for a first HARQ-ACK codebook associated with the data set 902 and a given BLER of P2 (e.g., the NACK probability) for a second HARQ-ACK codebook associated with the data set 904, corresponding codepoints for a joint data set for joint compression may be generated. In aspects, a network node or a UE may generate/determine a joint data set (e.g., a third compression data set, herein), where generation of the joint data set by a network node may be followed by provision/transmission for an indication thereof to the UE. The joint data set generation may assume that no correlation exists between a first HARQ-ACK codebook and a second HARQ-ACK codebook for ACK/NACK events.

The first compression data set 902 is shown for ACK/NACK events of a first HARQ-ACK codebook with N=5 and BLER=0.1 (iid), and the second compression data set 904 is shown for ACK/NACK events of a second HARQ-ACK codebook with N=4 and BLER=0.2 (iid). For a third compression data set associated with joint compression of the first and second HARQ-ACK codebooks, corresponding codepoints in the first compression data set 902 for the first HARQ-ACK codebook and in the second compression data set 904 for the second HARQ-ACK codebook may be combined to generate/determine codepoints 906 having a corresponding joint codebook value and joint probability (e.g., based on products of probabilities in the first compression data set 902 and the second compression data set 904). Accordingly, for aspects herein, a first compression data set for compression of a first HARQ-ACK codebook, a second compression data set for compression of a second HARQ-ACK codebook, and a third compression data set for joint compression of the first and second HARQ-ACK codebooks together may be utilized for lossless compression for HARQ-ACK codebooks with different BLER. Further details for joint data sets are described below with respect to FIG. 10.

FIG. 10 is a diagram 1000 illustrating example data sets for joint compression of codebooks with different BLER, in various aspects. The diagram 1000 shows a joint data set 1002 and joint data set 1004, each having four partitions and N₁=2, by way of example. The joint data set 1002 is shown, by way of example, as minimally optimized, while the joint data set 1004 is shown, by way of example, as fully optimized. The joint data set 1002 and the joint data set 1004 may be further aspects of FIG. 9 and the codepoints 906. That is, joint data sets may be based on data sets for two codebooks combined: a first HARQ-ACK codebook with N=5 bits, and a second HARQ-ACK codebook with M=4 bits (where M is used for illustrative distinction over N for clarity).

The joint data set 1002 represents a minimally optimized data set with an average bit length of 6.6313 for its codebook payloads, which is higher than two separate compressions (e.g., for the data set 502 in FIG. 5, two compressions gives 2.91+3.36). The four partitions of the joint data set 1002 include a first partition with 1 entry (e.g., codepoint), a second partition with 2 entries, a third partition with 4 entries, and a fourth partition with the remaining 505 entries.

The joint data set 1004 represents a fully optimized data set with an average bit length of 5.6469 for its codebook payloads, which is lower than two separate compressions (e.g., 2.91+3.13). The four partitions of the joint data set 1002 include a first partition with 1 entry (e.g., codepoint), a second partition with 8 entries, a third partition with 32 entries, and a fourth partition with the remaining 471 entries.

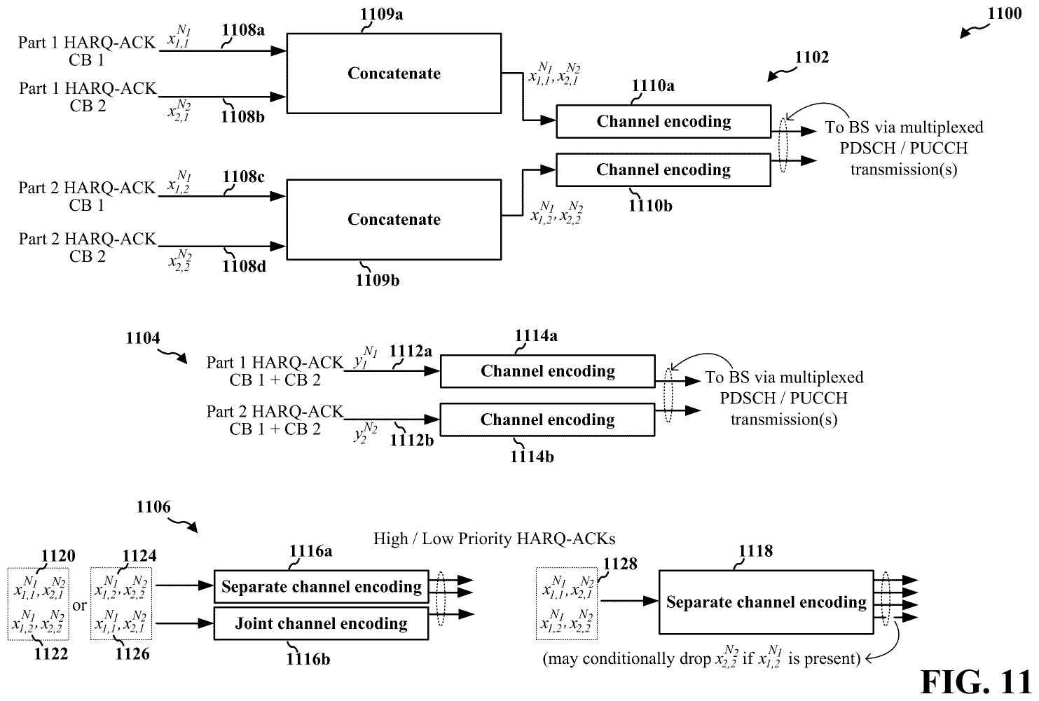

FIG. 11 is a diagram 1100 illustrating examples of multiplexing using compression of codebooks with different BLER, in various aspects. As noted above, aspects herein are also applicable to other relevant problems in wireless communication systems (e.g., simplifying UCI multiplexing on PUSCH/PUCCH procedures). The diagram 1100 shows a configuration 1102, a configuration 1104, and a configuration 1106, which may be further aspects subsequent to 806a, 806b, and 816 in FIG. 8, respectively) for examples of multiplexing using compression of codebooks with different BLER.

The configuration 1102 illustrates an example of separate compression. With two separate compressions for HARQ-ACK codebooks, a UE may have two part 1 HARQ-ACK portions and two part 2 HARQ-ACK portions after compression. In aspects, a UE may be configured to transform HARQ-ACK codebooks with bits x and different BLER (e.g., at 806a and at 806b in FIG. 8) for separate compression into a first part 1 HARQ-ACK codebook 1108a and a second part 1 HARQ-ACK codebook 1108b (e.g., two part 1 HARQ-ACK codebooks x_{1,1}^{N}^{₁} and x_{2,1}^{N}^{₂}), and into a first part 2 HARQ-ACK codebook 1108c and a second part 2 HARQ-ACK codebook 1108d (e.g., two part 2 HARQ-ACK codebooks x_{1,2}^{N}^{₁} and x_{2,2}^{N}^{₂}). The UE may be configured to concatenate (at 1109a) the two part 1 HARQ-ACK codebooks and treat them as if they were a single part 1 HARQ-ACK codebook [x_{1,1}^{N}^{₁},x_{2,1}^{N}^{₂}]. The UE may also be configured to concatenate (at 1109b) the two part 2 HARQ-ACK codebooks and treat them as if they were a single part 2 HARQ-ACK codebook [x_{1,2}^{N}^{₁},x_{2,2}^{N}^{₂}]. Accordingly, the UE has a single part 1 and a single part 2 compressed HARQ-ACK codebook, which the UE may be configured to encode (at 1110a and at 1110b, respectively) for transmission to a network node using UCI multiplexing mechanisms for PDSCH/PDCCH transmissions.

The configuration 1104 illustrates an example of joint compression. For joint compression, UE may have one part 1 and one part 2 HARQ-ACK codebook. In aspects, a UE may be configured to transform HARQ-ACK codebooks with bits x^{N} and different BLER (e.g., at 816 in FIG. 8) for joint compression into a part 1 HARQ-ACK codebook 1112a (e.g., a single part 1 HARQ-ACK codebook for the first and the second HARQ-ACK codebook y₁^{N}^{₁}), and into a part 2 HARQ-ACK codebook 1112b (e.g., a single part 2 HARQ-ACK codebook y₂^{N}^{₂}). With single part 1 and part 2 HARQ-ACK codebooks, concatenation by the UE (e.g., as utilized for separate compression in the configuration 1102) may be superfluous. Accordingly, the UE has a single part 1 and a single part 2 compressed HARQ-ACK codebook, which the UE may be configured to encode (at 1114a and at 1114b, respectively) for transmission to a network node using UCI multiplexing mechanisms for PDSCH/PDCCH transmissions.

The configuration 1106 shows additional aspects for encodings in the context of multiplexing using compression of codebooks with different BLER. The configuration 1106 shows examples for encodings of high/low priority HARQ-ACK codebooks. For instance, a UE may be configured to encode with a combination of separate channel encoding (at 1116a) and joint channel encoding (at 1116b). In aspects, the combination of encoding may be associated with high/low priority HARQ-ACK codebooks.

As one example, a UE may be configured to separately encode a part 1 of a low priority HARQ-ACK codebook and a part 1 of high priority HARQ-ACK codebook (e.g., codebooks 1120), but jointly encode a part 2 of low priority HARQ-ACK codebook and a part 2 of high priority HARQ-ACK codebook (e.g., codebooks 1120). Thus, three encodings may be present for transmission to a network node using UCI multiplexing mechanisms for PDSCH/PDCCH transmissions. In such scenarios, both part 1 codebooks may be decoded by the network node before the joint part 2 codebook can be decoded (e.g., if one of the two part 1 codebooks is not decoded, the base station may not be able to decode the joint part 2 codebook). However, the system benefits from the coding rate of the two part 1 codebooks being controlled separately for the two different priorities.

As another example, a UE may be configured to jointly encode a part 1 of a low priority HARQ-ACK codebook and a part 1 of high priority HARQ-ACK codebook (e.g., codebooks 1124), but separately encode a part 2 of low priority HARQ-ACK codebook and a part 2 of high priority HARQ-ACK codebook (e.g., codebooks 1126). Thus, three encodings may be present for transmission to a network node using UCI multiplexing mechanisms for PDSCH/PDCCH transmissions. In such scenarios, decoding the part 1 codebooks first by the network node, before the joint part 2 codebook can be decoded, is not an issue, and the system also benefits from the average number of encodings being smaller than 3 (e.g., for high priority, part 2 does not exist for most compressed codebooks if the jointly encoded part 1 codebook indicates all ACKs using a 1-bit part 1 configuration.

Another aspect shown in the configuration 1106 allows for four separate encodings. Such aspects may allow for the most straightforward combination of multiplexing across different priorities and two-Part HARQ-ACK feedback. While enabled, such an approach may be beyond three encoding chains on the PUSCH. For example, codebooks 1128 may each be separately encoded (at 1118) for a channel(s).

In furtherance of each of the codebooks 1128 being separately encoded (at 1118), aspects also provide for conditional dropping of one of the codebooks 1128 after being separately encoded (at 1118). By way of example, and as shown, if a part 2 of a high priority codebook (_{x1,2}^{N}^{₁}) exists or is present, then a UE may be configured to drop a part 2 of a low priority codebook (x_{2,2}^{N}^{₂}). Accordingly, while the UE may still encode each of the codebooks 1128 separately (e.g., encoded at 1118), dropping the part 2 of the low priority codebook (x_{2,2}^{N}^{₂}) allows for a maximum of three encodings on the PUSCH. In aspects, the probability of dropping part 2 of the low priority codebook (x_{2,2}^{N}^{₂}) may be low given that the part 2 of the high priority codebook (x_{1,2}^{N}^{₁}) may not exist or be present most of the time etc.

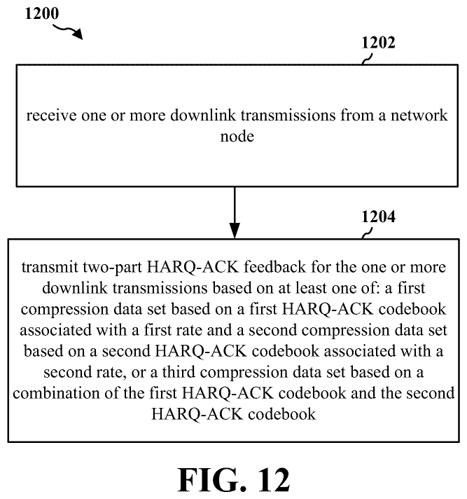

FIG. 12 is a flowchart 1200 of a method of wireless communication, in various aspects. The method may be performed by a UE (e.g., the UE 104, 702; the apparatus 1604). In some aspects, the method may include aspects described in connection with the communication flow in FIG. 7 and/or aspects described in FIGS. 5, 6, 8, 9, 10, 11. The method may be for lossless compression for HARQ-ACK codebooks with different BLER. The method may provide for separate and/or joint-compression of HARQ-ACK codebooks with different BLER that reduce HARQ-ACK payload size in terms of average payload lengths by minimizing codebooks in partitioned data sets utilized for compression of HARQ-ACK codebooks with different BLER based on occurrence likelihoods correlated with low bit lengths and enable efficient handling of codebooks with different BLER targets across TB/CBG PDSCHs, as well as high/low priority HARQ-ACK codebooks with different BLER by providing compression flexibility using separate- and/or joint-compression.

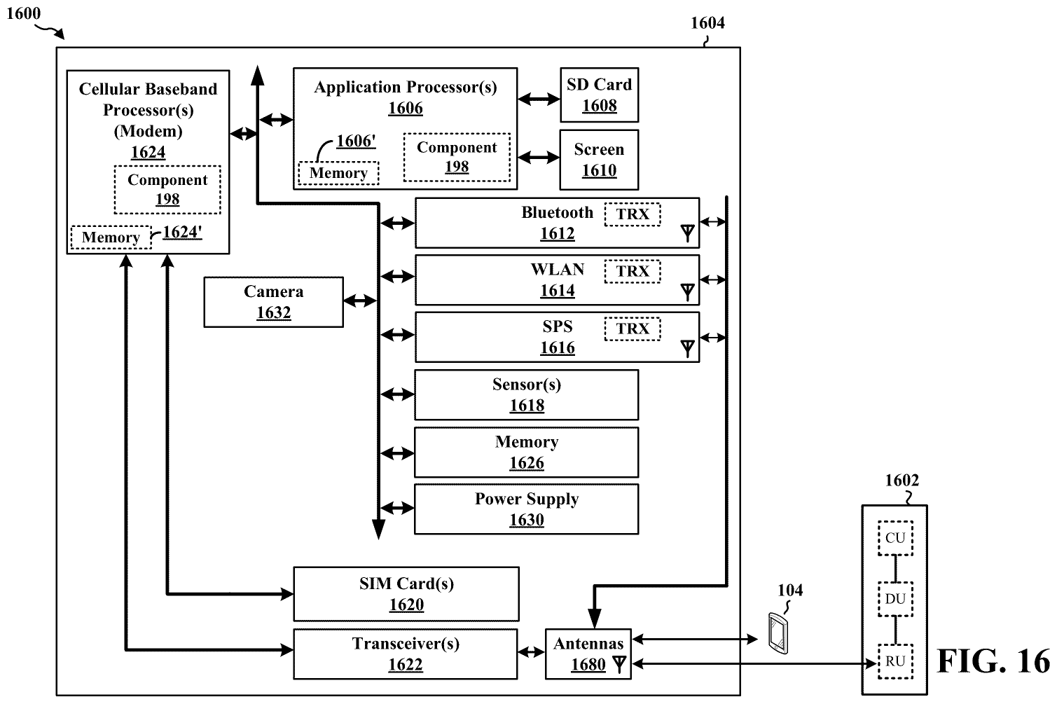

In 1202, the UE receives one or more downlink transmissions from a network node. As an example, the reception may be performed by one or more of the component 198, the transceiver(s) 1622, and/or the antenna 1680 in FIG. 16. FIG. 7 illustrates, in context of FIGS. 5-11, an example of the UE 702 receiving such a configuration(s) from a network node (e.g., the base station 704).

The UE 702 may be configured to receive, and the base station 704 may be configured to transmit/provide, a first and/or a second configuration 706. In aspects, the first configuration of the first and/or the second configuration 706 may be indicative of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10). The first compression data set (e.g., 502 in FIG. 5; 902 in FIG. 9) may be a data set associated with compression for a first HARQ-ACK codebook (e.g., 802, 812 in FIG. 8) of a first HARQ-ACK, the second compression data set (e.g., 502 in FIG. 5; 904 in FIG. 9) may be a data set associated with compression for a second HARQ-ACK codebook (e.g., 804, 814 in FIG. 8) of a second HARQ-ACK, and the third compression data set (e.g., 906 in FIG. 9; 1002, 1004 in FIG. 10) may be a data set associated with joint compression for the first HARQ-ACK codebook (e.g., 802, 812 in FIG. 8) of the first HARQ-ACK and the second HARQ-ACK codebook (e.g., 804, 814 in FIG. 8) of the second HARQ-ACK. The first compression data set (e.g., 502 in FIG. 5; 902 in FIG. 9), the second compression data set (e.g., 502 in FIG. 5; 904 in FIG. 9), and/or the third compression data set (e.g., 906 in FIG. 9; 1002, 1004 in FIG. 10) may be a partitioned data set that includes a first number of N-bit codepoint values, e.g., as described above for FIG. 5 and for FIGS. 9, 10. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. In aspects, the second configuration of the first and/or the second configuration 706 may be indicative of at least one of a first rate, a second rate, or a third rate. The first rate, the second rate, and the third rate may be BLERs associated with the first compression data set (e.g., 502 in FIG. 5; 902 in FIG. 9), the second compression data set (e.g., 502 in FIG. 5; 904 in FIG. 9), and the third compression data set (e.g., 906 in FIG. 9; 1002, 1004 in FIG. 10), respectively.

In 1204, the UE transmits two-part HARQ-ACK feedback for the one or more downlink transmissions based on at least one of: a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. As an example, the transmission may be performed by one or more of the component 198, the transceiver(s) 1622, and/or the antenna 1680 in FIG. 16. FIG. 7 illustrates, in context of FIGS. 5-11, an example of the UE 702 transmitting such two-part HARQ-ACK feedback for a network node (e.g., the base station 704).

The UE 702 may be configured to receive, and the base station 704 may be configured to transmit/provide, one or more DL transmissions 708. In some aspects, the UE 702 may be configured to receive, and the base station 704 and/or another base station (not shown for illustrative clarity and brevity) may be configured to transmit/provide, the one or more DL transmissions 708. That is, the one or more DL transmissions 708 may be included in a PDSCH(s) from the base station 704 (e.g., a PCell), or may be included in PDSCHs from the base station 704 (e.g., a PCell) and another base station (e.g., an SCell). The one or more DL transmissions 708 may include a first PDSCH that corresponds to the first HARQ-ACK codebook (e.g., 802, 812 in FIG. 8) of a HARQ-ACK and a second PDSCH that corresponds to the second HARQ-ACK codebook (e.g., 804, 814 in FIG. 8) of a HARQ-ACK. In aspects, the one or more DL transmissions 708 may include data/information for which the UE 702 generates a HARQ-ACK codebook(s) as feedback.

The UE 702 may be configured to generate, based on the one or more DL transmissions 708 from the base station 704, at least one of: a first HARQ-ACK codebook (e.g., 802, 812 in FIG. 8) associated with a HARQ-ACK and a first compression data set (e.g., 502 in FIG. 5; 902 in FIG. 9), a second HARQ-ACK codebook (e.g., 804, 814 in FIG. 8) associated with the HARQ-ACK and a second compression data set (e.g., 502 in FIG. 5; 904 in FIG. 9), or a third codebook associated with the HARQ-ACK and a third compression data set (e.g., 906 in FIG. 9; 1002, 1004 in FIG. 10). That is, HARQ-ACK codebooks may be generated by the UE 702 to indicate ACKs and/or NACKs for the one or more DL transmissions 708.

The UE 702 may be configured to select (at 710) one or more parts (e.g., 808a-d. 818a-b in FIG. 8; 1108a-d, 1112a-b, 1120, 1122, 1124, 1126, 1128 in FIG. 11) of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10) as two-part HARQ-ACK feedback. The UE 702 may be configured to select (at 710) a first compressed codebook and a second compressed codebook for at least one of a separate compression or a joint compression for the first and the second HARQ-ACK codebooks (e.g., 802, 812 and 804, 814 in FIG. 8). The separate compression may include two-part HARQ-ACK feedback, and may include a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d, 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11). The joint compression may be two-part HARQ-ACK feedback that includes jointly compressed feedback based on the third compression data set (e.g., 906 in FIG. 9; 1002, 1004 in FIG. 10). The two-part HARQ-ACK feedback may include a first part (e.g., 808a-b, 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b, 818a in FIG. 8; 1108a-b, 1112a, 1120, 1126, 1128 in FIG. 11). In aspects, the two-part HARQ-ACK feedback may include first parts (e.g., 808a-b. 818a in FIG. 8; 1108a-b, 1112a, 1120, 1126, 1128 in FIG. 11) of both the first HARQ-ACK codebook (e.g., 802, 812 in FIG. 8) and the second HARQ-ACK codebook (e.g., 804, 814 in FIG. 8) based on a third rate based on the third compression data set (e.g., 906 in FIG. 9; 1002, 1004 in FIG. 10), and second parts (e.g., 808c-d, 818b in FIG. 8; 1108c-d, 1112b, 1122, 1124, 1128 in FIG. 11) of both the first HARQ-ACK codebook (e.g., 802, 812 in FIG. 8) and the second HARQ-ACK codebook (e.g., 804, 814 in FIG. 8) based on the third rate.

The UE 702 may be configured to encode (at 712) (e.g., at 810a-d. 820a-b in FIG. 8; 1110a-b, 1114a-b, 1116a-b, 1118 in FIG. 11), as the payload for the two-part HARQ-ACK feedback 714, and for at least one associated channel in aspects, one or more parts (e.g., 808a-d, 818a-b in FIG. 8; 1108a-d, 1112a-b, 1120, 1122, 1124, 1126, 1128 in FIG. 11) of the two-part HARQ-ACK feedback. For instance, the UE 702 may be configured to encode (at 712) (e.g., at 810a-d. 820a-b in FIG. 8; 1110a-b, 1114a-b. 1116a-b, 1118 in FIG. 11) at least one of a first part (e.g., 808a-b, 818a in FIG. 8; 1108a-b, 1112a, 1120, 1126, 1128 in FIG. 11) of a first compressed codebook, the first part (e.g., 808a-b, 818a in FIG. 8; 1108a-b, 1112a, 1120, 1126, 1128 in FIG. 11) of a second compressed codebook, a second part (e.g., 808a-b, 818a in FIG. 8; 1108a-b. 1112a, 1120, 1126, 1128 in FIG. 11) of the first compressed codebook, or the second part (e.g., 808a-b, 818a in FIG. 8; 1108a-b, 1112a, 1120, 1126, 1128 in FIG. 11) of the second compressed codebook. As one example, the UE 702 may be configured to encode (at 712) (e.g., at 810a-d. 820a-b in FIG. 8; 1110a-b, 1114a-b, 1116a-b, 1118 in FIG. 11), separately, each of the first part (e.g., 808a-b, 818a in FIG. 8; 1108a-b, 1112a, 1120, 1126, 1128 in FIG. 11) of the first compressed codebook, the first part (e.g., 808a-b, 818a in FIG. 8; 1108a-b, 1112a, 1120, 1126, 1128 in FIG. 11) of the second compressed codebook, the second part (e.g., 808a-b, 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook. As another example, the UE 702 may be configured to encode (at 712) (e.g., at 810a-d. 820a-b in FIG. 8; 1110a-b, 1114a-b, 1116a-b, 1118 in FIG. 11), jointly, first parts (e.g., 808a-b, 818a in FIG. 8; 1108a-b, 1112a, 1120, 1126, 1128 in FIG. 11) of both a first compressed codebook and a second compressed codebook based on the third compression data set (e.g., 906 in FIG. 9; 1002, 1004 in FIG. 10), and second parts (e.g., 808c-d, 818b in FIG. 8; 1108c-d. 1112b, 1122, 1124, 1128 in FIG. 11) of both the first HARQ-ACK codebook (e.g., 802, 812 in FIG. 8) and the second HARQ-ACK codebook (e.g., 804, 814 in FIG. 8) based on the third compression data set (e.g., 906 in FIG. 9; 1002, 1004 in FIG. 10). As still another example, the UE 702 may be configured to encode (at 712) (e.g., at 810a-d, 820a-b in FIG. 8; 1110a-b, 1114a-b, 1116a-b, 1118 in FIG. 11), separately and jointly, ones of the first part (e.g., 808a-b, 818a in FIG. 8; 1108a-b, 1112a, 1120, 1126, 1128 in FIG. 11) of the first compressed codebook, the first part (e.g., 808a-b. 818a in FIG. 8; 1108a-b, 1112a, 1120, 1126, 1128 in FIG. 11) of the second compressed codebook, the second part (e.g., 808a-b. 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook.

The UE 702 may be configured to transmit/provide, and the base station 704 may be configured to receive, two-part HARQ-ACK feedback 714 for the one or more downlink transmissions. The two-part HARQ-ACK feedback 714 may include a HARQ-ACK payload (e.g., a payload representing the compressed parts (e.g., 808a-d, 818a-b in FIG. 8; 1108a-d, 1112a-b, 1120, 1122, 1124, 1126, 1128 in FIG. 11) of the HARQ-ACK codebooks selected (at 710) by the UE 702). The two-part HARQ-ACK feedback 714 based on at least one of a first compression data set (e.g., 502 in FIG. 5; 902 in FIG. 9) based on a first HARQ-ACK codebook (e.g., 802, 812 in FIG. 8) associated with a first rate and a second compression data set (e.g., 502 in FIG. 5; 904 in FIG. 9) based on a second HARQ-ACK codebook (e.g., 804, 814 in FIG. 8) associated with a second rate, or a third compression data set (e.g., 906 in FIG. 9; 1002, 1004 in FIG. 10) based on a combination of the first HARQ-ACK codebook (e.g., 802, 812 in FIG. 8) and the second HARQ-ACK codebook (e.g., 804, 814 in FIG. 8). The two-part HARQ-ACK feedback 714 may include two-part HARQ-ACK feedback, as described above, and may include a first compressed codebook and a second compressed codebook selected (at 710) by the UE 702 that represent a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d. 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11) for separate compression and/or that represent a first part (e.g., 808a-b, 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b, 818a in FIG. 8; 1108a-b, 1112a, 1120, 1126, 1128 in FIG. 11) for joint compression.

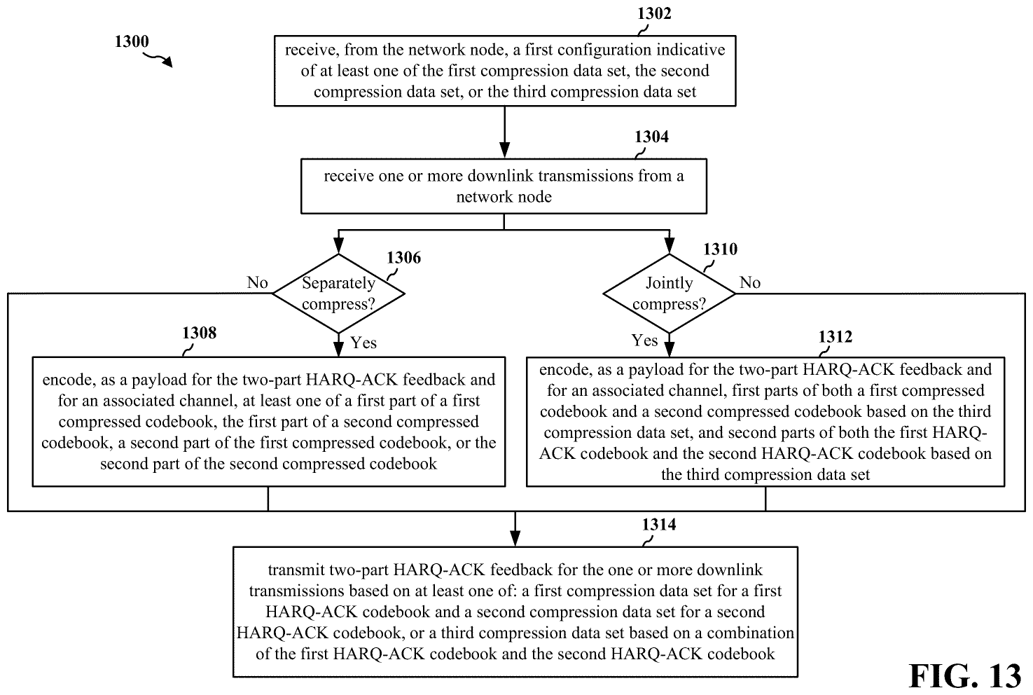

FIG. 13 is a flowchart 1300 of a method of wireless communication, in various aspects. The method may be performed by a UE (e.g., the UE 104, 702; the apparatus 1604). In some aspects, the method may include aspects described in connection with the communication flow in FIG. 7 and/or aspects described in FIGS. 5, 6, 8, 9, 10, 11. The method may be for lossless compression for HARQ-ACK codebooks with different BLER. The method may provide for separate and/or joint-compression of HARQ-ACK codebooks with different BLER that reduce HARQ-ACK payload size in terms of average payload lengths by minimizing codebooks in partitioned data sets utilized for compression of HARQ-ACK codebooks with different BLER based on occurrence likelihoods correlated with low bit lengths and enable efficient handling of codebooks with different BLER targets across TB/CBG PDSCHs, as well as high/low priority HARQ-ACK codebooks with different BLER by providing compression flexibility using separate- and/or joint-compression.

In 1302, the UE receives one or more downlink transmissions from a network node. As an example, the reception may be performed by one or more of the component 198, the transceiver(s) 1622, and/or the antenna 1680 in FIG. 16. FIG. 7 illustrates, in context of FIGS. 5-11, an example of the UE 702 receiving such a configuration(s) from a network node (e.g., the base station 704).

The UE 702 may be configured to receive, and the base station 704 may be configured to transmit/provide, a first and/or a second configuration 706. In aspects, the first configuration of the first and/or the second configuration 706 may be indicative of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10). The first compression data set (e.g., 502 in FIG. 5; 902 in FIG. 9) may be a data set associated with compression for a first HARQ-ACK codebook (e.g., 802, 812 in FIG. 8) of a first HARQ-ACK, the second compression data set (e.g., 502 in FIG. 5; 904 in FIG. 9) may be a data set associated with compression for a second HARQ-ACK codebook (e.g., 804, 814 in FIG. 8) of a second HARQ-ACK, and the third compression data set (e.g., 906 in FIG. 9; 1002, 1004 in FIG. 10) may be a data set associated with joint compression for the first HARQ-ACK codebook (e.g., 802, 812 in FIG. 8) of the first HARQ-ACK and the second HARQ-ACK codebook (e.g., 804, 814 in FIG. 8) of the second HARQ-ACK. The first compression data set (e.g., 502 in FIG. 5; 902 in FIG. 9), the second compression data set (e.g., 502 in FIG. 5; 904 in FIG. 9), and/or the third compression data set (e.g., 906 in FIG. 9; 1002, 1004 in FIG. 10) may be a partitioned data set that includes a first number of N-bit codepoint values, e.g., as described above for FIG. 5 and for FIGS. 9, 10. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. In aspects, the second configuration of the first and/or the second configuration 706 may be indicative of at least one of a first rate, a second rate, or a third rate. The first rate, the second rate, and the third rate may be BLERs associated with the first compression data set (e.g., 502 in FIG. 5; 902 in FIG. 9), the second compression data set (e.g., 502 in FIG. 5; 904 in FIG. 9), and the third compression data set (e.g., 906 in FIG. 9; 1002, 1004 in FIG. 10), respectively.

In 1304, the UE receives one or more downlink transmissions from a network node. As an example, the reception may be performed by one or more of the component 198, the transceiver(s) 1622, and/or the antenna 1680 in FIG. 16. FIG. 7 illustrates, in context of FIGS. 5-11, an example of the UE 702 receiving such a DL transmission(s) from a network node (e.g., the base station 704).

The UE 702 may be configured to receive, and the base station 704 may be configured to transmit/provide, one or more DL transmissions 708. In some aspects, the UE 702 may be configured to receive, and the base station 704 and/or another base station (not shown for illustrative clarity and brevity) may be configured to transmit/provide, the one or more DL transmissions 708. That is, the one or more DL transmissions 708 may be included in a PDSCH(s) from the base station 704 (e.g., a PCell), or may be included in PDSCHs from the base station 704 (e.g., a PCell) and another base station (e.g., an SCell). The one or more DL transmissions 708 may include a first PDSCH that corresponds to the first HARQ-ACK codebook (e.g., 802, 812 in FIG. 8) of a HARQ-ACK and a second PDSCH that corresponds to the second HARQ-ACK codebook (e.g., 804, 814 in FIG. 8) of a HARQ-ACK. In aspects, the one or more DL transmissions 708 may include data/information for which the UE 702 generates a HARQ-ACK codebook(s) as feedback.

The UE 702 may be configured to generate, based on the one or more DL transmissions 708 from the base station 704, at least one of: a first HARQ-ACK codebook (e.g., 802, 812 in FIG. 8) associated with a HARQ-ACK and a first compression data set (e.g., 502 in FIG. 5; 902 in FIG. 9), a second HARQ-ACK codebook (e.g., 804, 814 in FIG. 8) associated with the HARQ-ACK and a second compression data set (e.g., 502 in FIG. 5; 904 in FIG. 9), or a third codebook associated with the HARQ-ACK and a third compression data set (e.g., 906 in FIG. 9; 1002, 1004 in FIG. 10). That is, HARQ-ACK codebooks may be generated by the UE 702 to indicate ACKs and/or NACKs for the one or more DL transmissions 708.

The UE 702 may be configured to select (at 710) one or more parts (e.g., 808a-d. 818a-b in FIG. 8; 1108a-d, 1112a-b, 1120, 1122, 1124, 1126, 1128 in FIG. 11) of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10) as two-part HARQ-ACK feedback. The UE 702 may be configured to select (at 710) a first compressed codebook and a second compressed codebook for at least one of a separate compression or a joint compression for the first and the second HARQ-ACK codebooks (e.g., 802, 812 and 804, 814 in FIG. 8). The separate compression may include two-part HARQ-ACK feedback, and may include a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d. 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11). The joint compression may be two-part HARQ-ACK feedback that includes jointly compressed feedback based on the third compression data set (e.g., 906 in FIG. 9; 1002, 1004 in FIG. 10). The two-part HARQ-ACK feedback may include a first part (e.g., 808a-b, 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b, 818a in FIG. 8; 1108a-b, 1112a, 1120, 1126, 1128 in FIG. 11). In aspects, the two-part HARQ-ACK feedback may include first parts (e.g., 808a-b, 818a in FIG. 8; 1108a-b, 1112a, 1120, 1126, 1128 in FIG. 11) of both the first HARQ-ACK codebook (e.g., 802, 812 in FIG. 8) and the second HARQ-ACK codebook (e.g., 804, 814 in FIG. 8) based on a third rate based on the third compression data set (e.g., 906 in FIG. 9; 1002, 1004 in FIG. 10), and second parts (e.g., 808c-d, 818b in FIG. 8; 1108c-d, 1112b, 1122, 1124, 1128 in FIG. 11) of both the first HARQ-ACK codebook (e.g., 802, 812 in FIG. 8) and the second HARQ-ACK codebook (e.g., 804, 814 in FIG. 8) based on the third rate.

In 1306, the UE determines if separate compression has been utilized. If so, the flowchart 1300 continues to 1308; if not, the flowchart 1300 continues to 1314. As an example, the determination may be performed by one or more of the component 198, the transceiver(s) 1622, and/or the antenna 1680 in FIG. 16.

In 1308, the UE encodes, as a payload for the two-part HARQ-ACK feedback and for an associated channel, at least one of a first part of a first compressed codebook, the first part of a second compressed codebook, a second part of the first compressed codebook, or the second part of the second compressed codebook. As an example, the encoding may be performed by one or more of the component 198, the transceiver(s) 1622, and/or the antenna 1680 in FIG. 16. FIG. 7 illustrates, in context of FIGS. 5-11, an example of the UE 702 encoding such compressed codebook parts.

The UE 702 may be configured to encode (at 712) (e.g., at 810a-d, 820a-b in FIG. 8; 1110a-b, 1114a-b, 1116a-b, 1118 in FIG. 11), as the payload for the two-part HARQ-ACK feedback 714, and for at least one associated channel in aspects, one or more parts (e.g., 808a-d, 818a-b in FIG. 8; 1108a-d, 1112a-b, 1120, 1122, 1124, 1126, 1128 in FIG. 11) of the two-part HARQ-ACK feedback. For instance, the UE 702 may be configured to encode (at 712) (e.g., at 810a-d, 820a-b in FIG. 8; 1110a-b, 1114a-b, 1116a-b, 1118 in FIG. 11) at least one of a first part (e.g., 808a-b, 818a in FIG. 8; 1108a-b, 1112a, 1120, 1126, 1128 in FIG. 11) of a first compressed codebook, the first part (e.g., 808a-b. 818a in FIG. 8; 1108a-b, 1112a, 1120, 1126, 1128 in FIG. 11) of a second compressed codebook, a second part (e.g., 808a-b, 818a in FIG. 8; 1108a-b, 1112a, 1120, 1126, 1128 in FIG. 11) of the first compressed codebook, or the second part (e.g., 808a-b, 818a in FIG. 8; 1108a-b, 1112a, 1120, 1126, 1128 in FIG. 11) of the second compressed codebook. As one example, the UE 702 may be configured to encode (at 712) (e.g., at 810a-d. 820a-b in FIG. 8; 1110a-b, 1114a-b, 1116a-b, 1118 in FIG. 11), separately, each of the first part (e.g., 808a-b, 818a in FIG. 8; 1108a-b, 1112a, 1120, 1126, 1128 in FIG. 11) of the first compressed codebook, the first part (e.g., 808a-b, 818a in FIG. 8; 1108a-b, 1112a, 1120, 1126, 1128 in FIG. 11) of the second compressed codebook, the second part (e.g., 808a-b, 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook. As another example, the UE 702 may be configured to encode (at 712) (e.g., at 810a-d, 820a-b in FIG. 8; 1110a-b, 1114a-b, 1116a-b, 1118 in FIG. 11), jointly., first parts (e.g., 808a-b, 818a in FIG. 8; 1108a-b, 1112a, 1120, 1126, 1128 in FIG. 11) of both a first compressed codebook and a second compressed codebook based on the third compression data set (e.g., 906 in FIG. 9; 1002, 1004 in FIG. 10), and second parts (e.g., 808c-d, 818b in FIG. 8; 1108c-d. 1112b, 1122, 1124, 1128 in FIG. 11) of both the first HARQ-ACK codebook (e.g., 802, 812 in FIG. 8) and the second HARQ-ACK codebook (e.g., 804, 814 in FIG. 8) based on the third compression data set (e.g., 906 in FIG. 9; 1002, 1004 in FIG. 10). As still another example, the UE 702 may be configured to encode (at 712) (e.g., at 810a-d, 820a-b in FIG. 8; 1110a-b, 1114a-b, 1116a-b, 1118 in FIG. 11), separately and jointly, ones of the first part (e.g., 808a-b, 818a in FIG. 8; 1108a-b, 1112a, 1120, 1126, 1128 in FIG. 11) of the first compressed codebook, the first part (e.g., 808a-b, 818a in FIG. 8; 1108a-b, 1112a, 1120, 1126, 1128 in FIG. 11) of the second compressed codebook, the second part (e.g., 808a-b, 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook.

In 1310, the UE determines if joint compression has been utilized. If so, the flowchart 1300 continues to 1312; if not, the flowchart 1300 continues to 1314. As an example, the determination may be performed by one or more of the component 198, the transceiver(s) 1622, and/or the antenna 1680 in FIG. 16.

In 1312, the UE encodes, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set. As an example, the encoding may be performed by one or more of the component 198, the transceiver(s) 1622, and/or the antenna 1680 in FIG. 16. FIG. 7 illustrates, in context of FIGS. 5-11, an example of the UE 702 encoding such compressed codebook parts.

The UE 702 may be configured to encode (at 712) (e.g., at 810a-d. 820a-b in FIG. 8; 1110a-b, 1114a-b, 1116a-b, 1118 in FIG. 11), as the payload for the two-part HARQ-ACK feedback 714, and for at least one associated channel in aspects, one or more parts (e.g., 808a-d, 818a-b in FIG. 8; 1108a-d, 1112a-b, 1120, 1122, 1124, 1126, 1128 in FIG. 11) of the two-part HARQ-ACK feedback. For instance, the UE 702 may be configured to encode (at 712) (e.g., at 810a-d, 820a-b in FIG. 8; 1110a-b, 1114a-b, 1116a-b, 1118 in FIG. 11) at least one of a first part (e.g., 808a-b, 818a in FIG. 8; 1108a-b, 1112a, 1120, 1126, 1128 in FIG. 11) of a first compressed codebook, the first part (e.g., 808a-b, 818a in FIG. 8; 1108a-b, 1112a, 1120, 1126, 1128 in FIG. 11) of a second compressed codebook, a second part (e.g., 808a-b, 818a in FIG. 8; 1108a-b. 1112a, 1120, 1126, 1128 in FIG. 11) of the first compressed codebook, or the second part (e.g., 808a-b, 818a in FIG. 8; 1108a-b, 1112a, 1120, 1126, 1128 in FIG. 11) of the second compressed codebook. As one example, the UE 702 may be configured to encode (at 712) (e.g., at 810a-d. 820a-b in FIG. 8; 1110a-b, 1114a-b, 1116a-b, 1118 in FIG. 11), separately, each of the first part (e.g., 808a-b, 818a in FIG. 8; 1108a-b, 1112a, 1120, 1126, 1128 in FIG. 11) of the first compressed codebook, the first part (e.g., 808a-b, 818a in FIG. 8; 1108a-b, 1112a, 1120, 1126, 1128 in FIG. 11) of the second compressed codebook, the second part (e.g., 808a-b, 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook. As another example, the UE 702 may be configured to encode (at 712) (e.g., at 810a-d, 820a-b in FIG. 8; 1110a-b, 1114a-b, 1116a-b, 1118 in FIG. 11), jointly, first parts (e.g., 808a-b. 818a in FIG. 8; 1108a-b. 1112a, 1120, 1126, 1128 in FIG. 11) of both a first compressed codebook and a second compressed codebook based on the third compression data set (e.g., 906 in FIG. 9; 1002, 1004 in FIG. 10), and second parts (e.g., 808c-d, 818b in FIG. 8; 1108c-d, 1112b, 1122, 1124, 1128 in FIG. 11) of both the first HARQ-ACK codebook (e.g., 802, 812 in FIG. 8) and the second HARQ-ACK codebook (e.g., 804, 814 in FIG. 8) based on the third compression data set (e.g., 906 in FIG. 9; 1002, 1004 in FIG. 10). As still another example, the UE 702 may be configured to encode (at 712) (e.g., at 810a-d, 820a-b in FIG. 8; 1110a-b, 1114a-b, 1116a-b, 1118 in FIG. 11), separately and jointly, ones of the first part (e.g., 808a-b. 818a in FIG. 8; 1108a-b, 1112a, 1120, 1126, 1128 in FIG. 11) of the first compressed codebook, the first part (e.g., 808a-b, 818a in FIG. 8; 1108a-b, 1112a, 1120, 1126, 1128 in FIG. 11) of the second compressed codebook, the second part (e.g., 808a-b, 818a in FIG. 8; 1108a-b, 1112a, 1120, 1126, 1128 in FIG. 11) of the first compressed codebook, and the second part (e.g., 808a-b, 818a in FIG. 8; 1108a-b, 1112a, 1120, 1126, 1128 in FIG. 11) of the second compressed codebook.

In 1312, the UE transmits two-part HARQ-ACK feedback for the one or more downlink transmissions based on at least one of: a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. As an example, the transmission may be performed by one or more of the component 198, the transceiver(s) 1622, and/or the antenna 1680 in FIG. 16. FIG. 7 illustrates, in context of FIGS. 5-11, an example of the UE 702 transmitting such two-part HARQ-ACK feedback for a network node (e.g., the base station 704).

The UE 702 may be configured to transmit/provide, and the base station 704 may be configured to receive, two-part HARQ-ACK feedback 714 for the one or more downlink transmissions. The two-part HARQ-ACK feedback 714 may include a HARQ-ACK payload (e.g., a payload representing the compressed parts (e.g., 808a-d, 818a-b in FIG. 8; 1108a-d, 1112a-b, 1120, 1122, 1124, 1126, 1128 in FIG. 11) of the HARQ-ACK codebooks selected (at 710) by the UE 702). The two-part HARQ-ACK feedback 714 based on at least one of a first compression data set (e.g., 502 in FIG. 5; 902 in FIG. 9) based on a first HARQ-ACK codebook (e.g., 802, 812 in FIG. 8) associated with a first rate and a second compression data set (e.g., 502 in FIG. 5; 904 in FIG. 9) based on a second HARQ-ACK codebook (e.g., 804, 814 in FIG. 8) associated with a second rate, or a third compression data set (e.g., 906 in FIG. 9; 1002, 1004 in FIG. 10) based on a combination of the first HARQ-ACK codebook (e.g., 802, 812 in FIG. 8) and the second HARQ-ACK codebook (e.g., 804, 814 in FIG. 8). The two-part HARQ-ACK feedback 714 may include two-part HARQ-ACK feedback, as described above, and may include a first compressed codebook and a second compressed codebook selected (at 710) by the UE 702 that represent a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d, 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11) for separate compression and/or that represent a first part (e.g., 808a-b, 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b, 818a in FIG. 8; 1108a-b, 1112a, 1120, 1126, 1128 in FIG. 11) for joint compression.

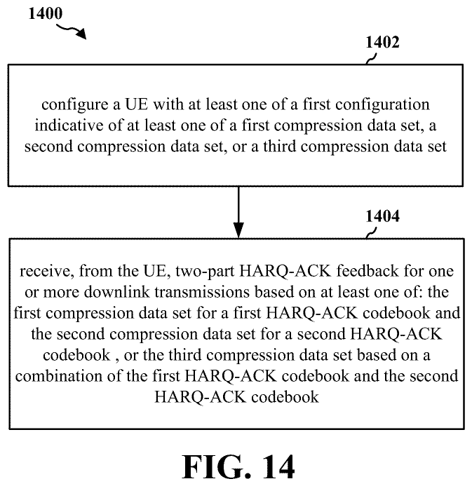

FIG. 14 is a flowchart 1400 of a method of wireless communication, in various aspects. The method may be performed by a network node, such as a base station, gNB, etc. (e.g., the base station 102, 704; the network entity 1602, 1702). In some aspects, the method may include aspects described in connection with the communication flow in FIG. 7 and/or aspects described in FIGS. 5, 6, 8, 9, 10, 11. The method may be for lossless compression for HARQ-ACK codebooks with different BLER. The method may provide for separate and/or joint-compression of HARQ-ACK codebooks with different BLER that reduce HARQ-ACK payload size in terms of average payload lengths by minimizing codebooks in partitioned data sets utilized for compression of HARQ-ACK codebooks with different BLER based on occurrence likelihoods correlated with low bit lengths and enable efficient handling of codebooks with different BLER targets across TB/CBG PDSCHs, as well as high/low priority HARQ-ACK codebooks with different BLER by providing compression flexibility using separate- and/or joint-compression.

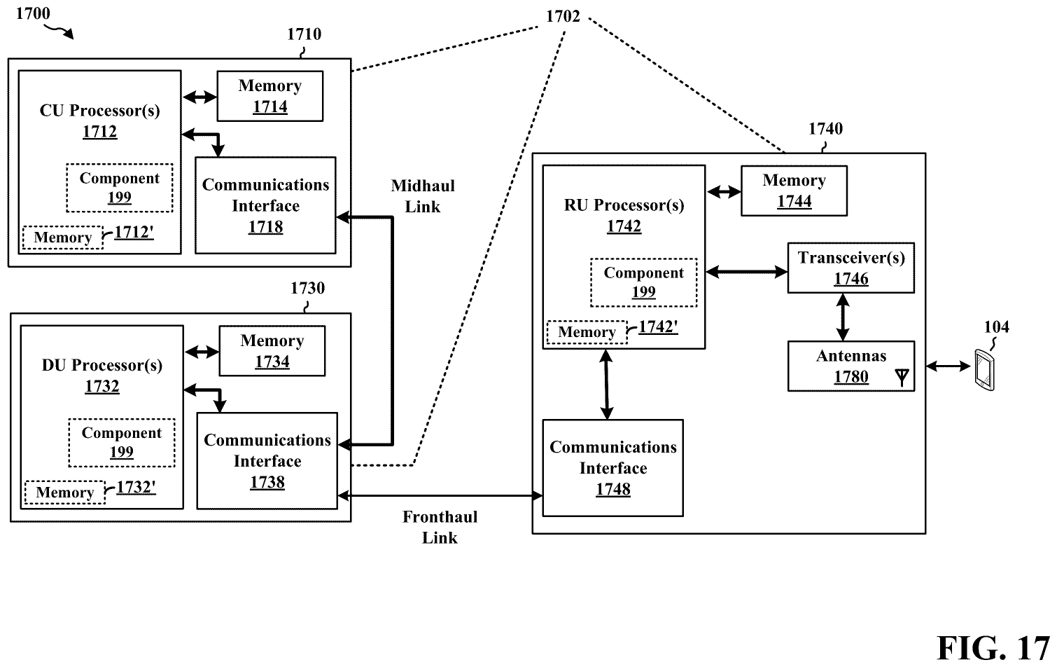

In 1402, the network node configures a UE with at least one of (i) a first configuration indicative of at least one of a first compression data set, a second compression data set, or a third compression data set, or (ii) a second configuration indicative of at least one of a first rate, a second rate, or a third rate. As an example, the configuration may be performed by one or more of the component 199, the transceiver(s) 1746, and/or the antenna 1780 in FIG. 17. FIG. 7 illustrates, in context of FIGS. 5-11, an example of a network node (e.g., the base station 704) so configuring a UE (e.g., the UE 702).

The base station 704 may be configured to receive, and the UE 702 may be configured to transmit/provide, a first and/or a second configuration 706. In aspects, the first configuration of the first and/or the second configuration 706 may be indicative of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10). The first compression data set (e.g., 502 in FIG. 5; 902 in FIG. 9) may be a data set associated with compression for a first HARQ-ACK codebook (e.g., 802, 812 in FIG. 8) of a first HARQ-ACK, the second compression data set (e.g., 502 in FIG. 5; 904 in FIG. 9) may be a data set associated with compression for a second HARQ-ACK codebook (e.g., 804, 814 in FIG. 8) of a second HARQ-ACK, and the third compression data set (e.g., 906 in FIG. 9; 1002, 1004 in FIG. 10) may be a data set associated with joint compression for the first HARQ-ACK codebook (e.g., 802, 812 in FIG. 8) of the first HARQ-ACK and the second HARQ-ACK codebook (e.g., 804, 814 in FIG. 8) of the second HARQ-ACK. The first compression data set (e.g., 502 in FIG. 5; 902 in FIG. 9), the second compression data set (e.g., 502 in FIG. 5; 904 in FIG. 9), and/or the third compression data set (e.g., 906 in FIG. 9; 1002, 1004 in FIG. 10) may be a partitioned data set that includes a first number of N-bit codepoint values, e.g., as described above for FIG. 5 and for FIGS. 9, 10. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. In aspects, the second configuration of the first and/or the second configuration 706 may be indicative of at least one of a first rate, a second rate, or a third rate. The first rate, the second rate, and the third rate may be BLERs associated with the first compression data set (e.g., 502 in FIG. 5; 902 in FIG. 9), the second compression data set (e.g., 502 in FIG. 5; 904 in FIG. 9), and the third compression data set (e.g., 906 in FIG. 9; 1002, 1004 in FIG. 10), respectively.

In 1404, the network node receives, from the UE, two-part HARQ-ACK feedback for one or more downlink transmissions based on at least one of: the first compression data set based on a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook. As an example, the reception may be performed by one or more of the component 199, the transceiver(s) 1746, and/or the antenna 1780 in FIG. 17. FIG. 7 illustrates, in context of FIGS. 5-11, an example of a network node (e.g., the base station 704) receiving such two-part HARQ-ACK feedback from a UE (e.g., the UE 702).

The base station 704 may be configured to receive, and the UE 702 may be configured to transmit/provide, two-part HARQ-ACK feedback 714 for the one or more downlink transmissions. The two-part HARQ-ACK feedback 714 may include a HARQ-ACK payload (e.g., a payload representing the compressed parts (e.g., 808a-d. 818a-b in FIG. 8; 1108a-d, 1112a-b, 1120, 1122, 1124, 1126, 1128 in FIG. 11) of the HARQ-ACK codebooks selected (at 710) by the UE 702). The two-part HARQ-ACK feedback 714 based on at least one of a first compression data set (e.g., 502 in FIG. 5; 902 in FIG. 9) based on a first HARQ-ACK codebook (e.g., 802, 812 in FIG. 8) associated with a first rate and a second compression data set (e.g., 502 in FIG. 5; 904 in FIG. 9) based on a second HARQ-ACK codebook (e.g., 804, 814 in FIG. 8) associated with a second rate, or a third compression data set (e.g., 906 in FIG. 9; 1002, 1004 in FIG. 10) based on a combination of the first HARQ-ACK codebook (e.g., 802, 812 in FIG. 8) and the second HARQ-ACK codebook (e.g., 804, 814 in FIG. 8). The two-part HARQ-ACK feedback 714 may include two-part HARQ-ACK feedback, as described above, and may include a first compressed codebook and a second compressed codebook selected (at 710) by the UE 702 that represent a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d, 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11) for separate compression and/or that represent a first part (e.g., 808a-b, 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b. 818a in FIG. 8; 1108a-b, 1112a, 1120, 1126, 1128 in FIG. 11) for joint compression.

As noted herein, the base station 704 may be configured to transmit/provide, and the UE 702 may be configured to receive, one or more DL transmissions 708. In some aspects, the UE 702 may be configured to receive, and the base station 704 and/or another base station (not shown for illustrative clarity and brevity) may be configured to transmit/provide, the one or more DL transmissions 708. That is, the one or more DL transmissions 708 may be included in a PDSCH(s) from the base station 704 (e.g., a PCell), or may be included in PDSCHs from the base station 704 (e.g., a PCell) and another base station (e.g., an SCell). The one or more DL transmissions 708 may include a first PDSCH that corresponds to the first HARQ-ACK codebook (e.g., 802, 812 in FIG. 8) of a HARQ-ACK and a second PDSCH that corresponds to the second HARQ-ACK codebook (e.g., 804, 814 in FIG. 8) of a HARQ-ACK. In aspects, the one or more DL transmissions 708 may include data/information for which the UE 702 generates a HARQ-ACK codebook(s) as feedback. The UE 702 may be configured to perform selection and encoding operations/functions, as described herein (e.g., with respect to FIGS. 7-13) in order to transmit the two-part HARQ-ACK feedback 714 to be received by the base station 704.

The base station 704 may be configured to subsequently decode the payload of the two-part HARQ-ACK feedback 714 based on at least one of the first configuration or the second configuration (e.g., the first and/or the second configuration 706).

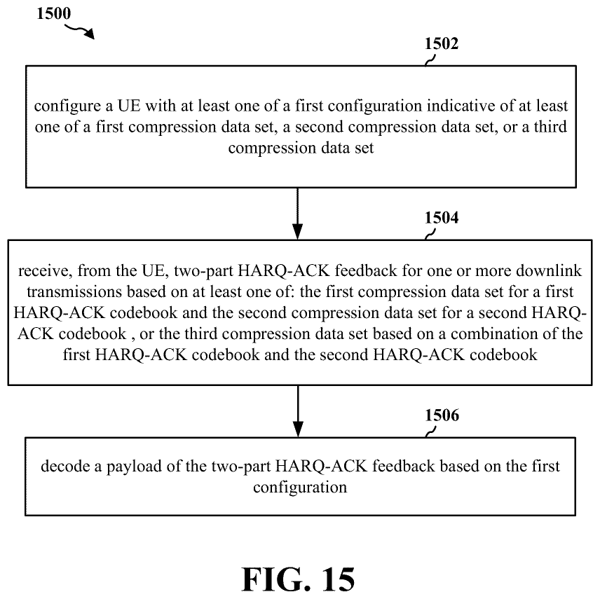

FIG. 15 is a flowchart 1500 of a method of wireless communication, in various aspects. The method may be performed by a network node, such as a base station, gNB, etc. (e.g., the base station 102, 704; the network entity 1602, 1702). In some aspects, the method may include aspects described in connection with the communication flow in FIG. 7 and/or aspects described in FIGS. 5, 6, 8, 9, 10, 11. The method may be for lossless compression for HARQ-ACK codebooks with different BLER. The method may provide for separate and/or joint-compression of HARQ-ACK codebooks with different BLER that reduce HARQ-ACK payload size in terms of average payload lengths by minimizing codebooks in partitioned data sets utilized for compression of HARQ-ACK codebooks with different BLER based on occurrence likelihoods correlated with low bit lengths and enable efficient handling of codebooks with different BLER targets across TB/CBG PDSCHs, as well as high/low priority HARQ-ACK codebooks with different BLER by providing compression flexibility using separate- and/or joint-compression.

In 1502, the network node configures a UE with at least one of (i) a first configuration indicative of at least one of a first compression data set, a second compression data set, or a third compression data set, or (ii) a second configuration indicative of at least one of a first rate, a second rate, or a third rate. As an example, the configuration may be performed by one or more of the component 199, the transceiver(s) 1746, and/or the antenna 1780 in FIG. 17. FIG. 7 illustrates, in context of FIGS. 5-11, an example of a network node (e.g., the base station 704) so configuring a UE (e.g., the UE 702).

The base station 704 may be configured to receive, and the UE 702 may be configured to transmit/provide, a first and/or a second configuration 706. In aspects, the first configuration of the first and/or the second configuration 706 may be indicative of at least one of a first compression data set (e.g., 502 in FIG. 5; 902 in FIG. 9), a second compression data set (e.g., 502 in FIG. 5; 904 in FIG. 9), or a third compression data set (e.g., 906 in FIG. 9; 1002, 1004 in FIG. 10). The first compression data set (e.g., 502 in FIG. 5; 902 in FIG. 9) may be a data set associated with compression for a first HARQ-ACK codebook (e.g., 802, 812 in FIG. 8) of a first HARQ-ACK, the second compression data set (e.g., 502 in FIG. 5; 904 in FIG. 9) may be a data set associated with compression for a second HARQ-ACK codebook (e.g., 804, 814 in FIG. 8) of a second HARQ-ACK, and the third compression data set (e.g., 906 in FIG. 9; 1002, 1004 in FIG. 10) may be a data set associated with joint compression for the first HARQ-ACK codebook (e.g., 802, 812 in FIG. 8) of the first HARQ-ACK and the second HARQ-ACK codebook (e.g., 804, 814 in FIG. 8) of the second HARQ-ACK. The first compression data set (e.g., 502 in FIG. 5; 902 in FIG. 9), the second compression data set (e.g., 502 in FIG. 5; 904 in FIG. 9), and/or the third compression data set (e.g., 906 in FIG. 9; 1002, 1004 in FIG. 10) may be a partitioned data set that includes a first number of N-bit codepoint values, e.g., as described above for FIG. 5 and for FIGS. 9, 10. In aspects, each of the first number of N-bit codepoint values may be associated with a respective first part (e.g., part 1 of a HARQ-ACK codebook) and a respective second part (e.g., part 2 of a HARQ-ACK codebook), and N may be a positive integer. In aspects, the second configuration of the first and/or the second configuration 706 may be indicative of at least one of a first rate, a second rate, or a third rate. The first rate, the second rate, and the third rate may be BLERs associated with the first compression data set (e.g., 502 in FIG. 5; 902 in FIG. 9), the second compression data set (e.g., 502 in FIG. 5; 904 in FIG. 9), and the third compression data set (e.g., 906 in FIG. 9; 1002, 1004 in FIG. 10), respectively.

In 1504, the network node receives, from the UE, two-part HARQ-ACK feedback for one or more downlink transmissions based on at least one of: the first compression data set based on a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook. As an example, the reception may be performed by one or more of the component 199, the transceiver(s) 1746, and/or the antenna 1780 in FIG. 17. FIG. 7 illustrates, in context of FIGS. 5-11, an example of a network node (e.g., the base station 704) receiving such two-part HARQ-ACK feedback from a UE (e.g., the UE 702).

The base station 704 may be configured to receive, and the UE 702 may be configured to transmit/provide, two-part HARQ-ACK feedback 714 for the one or more downlink transmissions. The two-part HARQ-ACK feedback 714 may include a HARQ-ACK payload (e.g., a payload representing the compressed parts (e.g., 808a-d. 818a-b in FIG. 8; 1108a-d, 1112a-b, 1120, 1122, 1124, 1126, 1128 in FIG. 11) of the HARQ-ACK codebooks selected (at 710) by the UE 702). The two-part HARQ-ACK feedback 714 based on at least one of a first compression data set (e.g., 502 in FIG. 5; 902 in FIG. 9) based on a first HARQ-ACK codebook (e.g., 802, 812 in FIG. 8) associated with a first rate and a second compression data set (e.g., 502 in FIG. 5; 904 in FIG. 9) based on a second HARQ-ACK codebook (e.g., 804, 814 in FIG. 8) associated with a second rate, or a third compression data set (e.g., 906 in FIG. 9; 1002, 1004 in FIG. 10) based on a combination of the first HARQ-ACK codebook (e.g., 802, 812 in FIG. 8) and the second HARQ-ACK codebook (e.g., 804, 814 in FIG. 8). The two-part HARQ-ACK feedback 714 may include two-part HARQ-ACK feedback, as described above, and may include a first compressed codebook and a second compressed codebook selected (at 710) by the UE 702 that represent a first part (e.g., 808a-b, 818a in FIG. 8; 1108a-b, 1112a, 1120, 1126, 1128 in FIG. 11) indicating a first group within the first compression data set (e.g., 502 in FIG. 5; 902 in FIG. 9) that partitions the first HARQ-ACK codebook (e.g., 802, 812 in FIG. 8) into a first set of multiple groups and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) within the first group indicated in the first part (e.g., 808a-b, 818a in FIG. 8; 1108a-b, 1112a, 1120, 1126, 1128 in FIG. 11), and a third part (e.g., 808c-d, 818b in FIG. 8; 1108c-d, 1112b, 1122, 1124, 1128 in FIG. 11) indicating a second group within the second compression data set (e.g., 502 in FIG. 5; 904 in FIG. 9) that partitions the second HARQ-ACK codebook (e.g., 804, 814 in FIG. 8) into a second set of multiple groups and a fourth part (e.g., 808c-d, 818b in FIG. 8; 1108c-d, 1112b, 1122, 1124, 1128 in FIG. 11) indicating a second codepoint of the second HARQ-ACK codebook (e.g., 804, 814 in FIG. 8) within the second group indicated in the third part (e.g., 808c-d, 818b in FIG. 8; 1108c-d, 1112b, 1122, 1124, 1128 in FIG. 11) for separate compression and/or that represent a first part (e.g., 808a-b. 818a in FIG. 8; 1108a-b, 1112a, 1120, 1126, 1128 in FIG. 11) indicating a group within the third compression data set (e.g., 906 in FIG. 9; 1002, 1004 in FIG. 10) that partitions the combination of the first HARQ-ACK codebook (e.g., 802, 812 in FIG. 8) and the second HARQ-ACK codebook (e.g., 804, 814 in FIG. 8) into multiple groups, and a second part (e.g., 808a-b, 818a in FIG. 8; 1108a-b, 1112a, 1120, 1126, 1128 in FIG. 11) indicating a first codepoint of the first HARQ-ACK codebook (e.g., 802, 812 in FIG. 8) and a second codepoint of the second HARQ-ACK codebook (e.g., 804, 814 in FIG. 8) based on the group within the third compression data set (e.g., 906 in FIG. 9; 1002, 1004 in FIG. 10) that is indicated in the first part (e.g., 808a-b, 818a in FIG. 8; 1108a-b, 1112a, 1120, 1126, 1128 in FIG. 11) for joint compression.

As noted herein, the base station 704 may be configured to transmit/provide, and the UE 702 may be configured to receive, one or more DL transmissions 708. In some aspects, the UE 702 may be configured to receive, and the base station 704 and/or another base station (not shown for illustrative clarity and brevity) may be configured to transmit/provide, the one or more DL transmissions 708. That is, the one or more DL transmissions 708 may be included in a PDSCH(s) from the base station 704 (e.g., a PCell), or may be included in PDSCHs from the base station 704 (e.g., a PCell) and another base station (e.g., an SCell). The one or more DL transmissions 708 may include a first PDSCH that corresponds to the first HARQ-ACK codebook (e.g., 802, 812 in FIG. 8) of a HARQ-ACK and a second PDSCH that corresponds to the second HARQ-ACK codebook (e.g., 804, 814 in FIG. 8) of a HARQ-ACK. In aspects, the one or more DL transmissions 708 may include data/information for which the UE 702 generates a HARQ-ACK codebook(s) as feedback. The UE 702 may be configured to perform selection and encoding operations/functions, as described herein (e.g., with respect to FIGS. 7-13) in order to transmit the two-part HARQ-ACK feedback 714 to be received by the base station 704.

In 1506, the network node decodes a payload of the two-part HARQ-ACK feedback based on at least one of the first configuration or the second configuration. As an example, the decoding may be performed by one or more of the component 199, the transceiver(s) 1746, and/or the antenna 1780 in FIG. 17. FIG. 7 illustrates, in context of FIGS. 5-11, an example of a network node (e.g., the base station 704) decoding such two-part HARQ-ACK feedback received from a UE (e.g., the UE 702).

The base station 704 may be configured to subsequently decode the payload of the two-part HARQ-ACK feedback 714 based on at least one of the first configuration or the second configuration (e.g., the first and/or the second configuration 706).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the component 198 may be configured to receive one or more downlink transmissions from a network node. The component 198 may also be configured to transmit two-part HARQ-ACK feedback for the one or more downlink transmissions based on at least one of: a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. The component 198 may be configured to receive, from the network node, a first configuration indicative of at least one of the first compression data set, the second compression data set, or the third compression data set. The component 198 may be configured to encode, as a payload for the two-part HARQ-ACK feedback and for an associated channel, at least one of a first part of a first compressed codebook, the first part of a second compressed codebook, a second part of the first compressed codebook, or the second part of the second compressed codebook. The component 198 may be configured to encode, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set. The component 198 may be further configured to perform any of the aspects described in connection with the flowcharts in any of FIGS. 12, 13, 14, 15 and/or any of the aspects performed by a UE for any of FIGS. 4-11. The component 198 may be within the cellular baseband processor(s) 1624, the application processor(s) 1606, or both the cellular baseband processor(s) 1624 and the application processor(s) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for receiving one or more downlink transmissions from a network node. In the configuration, the apparatus 1604, and in particular the cellular baseband processor(s) 1624 and/or the application processor(s) 1606, may include means for transmitting two-part HARQ-ACK feedback for the one or more downlink transmissions based on at least one of: a first compression data set based on a first HARQ-ACK codebook associated with a first rate and a second compression data set based on a second HARQ-ACK codebook associated with a second rate, or a third compression data set based on a combination of the first HARQ-ACK codebook and the second HARQ-ACK codebook. In one configuration, the apparatus 1604, and in particular the cellular baseband processor(s) 1624 and/or the application processor(s) 1606, may include means for receiving, from the network node, a first configuration indicative of at least one of the first compression data set, the second compression data set, or the third compression data set. In one configuration, the apparatus 1604, and in particular the cellular baseband processor(s) 1624 and/or the application processor(s) 1606, may include means for encoding, as a payload for the two-part HARQ-ACK feedback and for an associated channel, at least one of a first part of a first compressed codebook, the first part of a second compressed codebook, a second part of the first compressed codebook, or the second part of the second compressed codebook. In one configuration, the apparatus 1604, and in particular the cellular baseband processor(s) 1624 and/or the application processor(s) 1606, may include means for encoding, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with at least one of (i) a first configuration indicative of at least one of a first compression data set, a second compression data set, or a third compression data set, or (ii) a second configuration indicative of at least one of a first rate, a second rate, or a third rate. The component 199 may also be configured to receive, from the UE, two-part HARQ-ACK feedback for one or more downlink transmissions based on at least one of: the first compression data set based on a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook. The component 199 may be configured to decode a payload of the two-part HARQ-ACK feedback based on at least one of the first configuration or the second configuration. The component 199 may be further configured to perform any of the aspects described in connection with the flowcharts in any of FIGS. 12, 13, 14, 15 and/or any of the aspects performed by a network node, base station, gNB, etc., for any of FIGS. 4-11. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for configuring a UE with at least one of (i) a first configuration indicative of at least one of a first compression data set, a second compression data set, or a third compression data set, or (ii) a second configuration indicative of at least one of a first rate, a second rate, or a third rate. In the configuration, the network entity 1702 may include means for receiving, from the UE, two-part HARQ-ACK feedback for one or more downlink transmissions based on at least one of: the first compression data set based on a first HARQ-ACK codebook associated with the first rate and the second compression data set based on a second HARQ-ACK codebook associated with the second rate, or the third compression data set based on a combination of the first HARQ-ACK codebook and the second HARQ-ACK codebook. In one configuration, the network entity 1702 may include means for decoding a payload of the two-part HARQ-ACK feedback based on at least one of the first configuration or the second configuration. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks, may be designed to support communications between network nodes and UEs. For instance, a network node may receive a HARQ-ACK from a UE based on DL signaling. In 5G NR, a HARQ-ACK that includes N bits may have 2^{N} codepoints that are not equally likely to occur. This may be due to a BLER target that is less than or equal to 10% (e.g., 0.1), but also may be due to correlations in time, frequency, and/or layers (e.g., across slots, code block groups (CBGs), component carriers (CCs), transport blocks (TBs), etc.). To minimize HARQ-ACK payloads, compression may be implemented, which may present source coding problems with optimal lossless compression (e.g., entropy). A two-part HARQ-ACK may provide for compression mechanisms, where the two part are separately encoded, the network node decodes the first part before the second part, and the size and interpretation of the second part depends on the indicated codepoint of the first part. Thus, two-part HARQ-ACKs may achieve close to optimal compression in terms of average HARQ-ACK payload length. However, when two HARQ-ACK codebooks are designed with different BLER targets, issues may arise for optimizing compression of the codebooks. Additionally, there is a lack of solutions for encoding of the compressed codebooks of two HARQ-ACKs with different BLER targets. As one example, the handling of different (sub) codebooks of HARQ-ACKs for TB-based PDSCH (e.g., for a primary cell (PCell)) and CBG-based PDSCH (e.g., for a secondary cell (SCell)) may cause issues with transmissions thereof. As another example, the handling of both high priority and low priority HARQ-ACK codebooks for a PDSCH lacks existing solutions.

Aspects herein for lossless compression for HARQ-ACK codebooks with different BLER provide compression for HARQ-ACK codebooks with different BLER that may be optimized for separate compression of the codebooks, or compression for HARQ-ACK codebooks with different BLER may be optimized for joint compression of the codebooks. Compression for HARQ-ACK codebooks with different BLER may also be optimized for a combination of separate/joint compression of the codebooks. In some aspects, compression for HARQ-ACK codebooks with different BLER may be optimized using joint compression with a joint data set that is based on two data sets for single codebook compression of two different HARQ-ACKs, respectively. Aspects reduce HARQ-ACK payload size in terms of average payload lengths by minimizing codebooks in partitioned data sets utilized for compression of HARQ-ACK codebooks with different BLER based on occurrence likelihoods correlated with low bit lengths. Aspects also enable efficient handling of codebooks with different BLER targets across TB/CBG PDSCHs, as well as high/low priority HARQ-ACK codebooks with different BLER by providing compression flexibility using separate- and/or joint-compression.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: receiving one or more downlink transmissions from a network node; and transmitting two-part hybrid automatic repeat request (HARQ) acknowledgement (HARQ-ACK) feedback for the one or more downlink transmissions based on at least one of: a first compression data set for a first HARQ-ACK codebook and a second compression data set for a second HARQ-ACK codebook, or a third compression data set based on a combination of the first HARQ-ACK codebook and the second HARQ-ACK codebook.
Aspect 2 is the method of aspect 1, wherein the two-part HARQ-ACK feedback includes two-part HARQ-ACK feedback, including: a first part indicating a first group within the first compression data set that partitions the first HARQ-ACK codebook into a first set of multiple groups and a second part indicating a first codepoint of the first HARQ-ACK codebook within the first group indicated in the first part, and a third part indicating a second group within the second compression data set that partitions the second HARQ-ACK codebook into a second set of multiple groups and a fourth part indicating a second codepoint of the second HARQ-ACK codebook within the second group indicated in the third part.
Aspect 3 is the method of aspect 1, wherein the two-part HARQ-ACK feedback includes jointly compressed feedback based on the third compression data set.
Aspect 4 is the method of aspect 3, wherein the two-part HARQ-ACK feedback includes: a first part indicating a group within the third compression data set that partitions the combination of the first HARQ-ACK codebook and the second HARQ-ACK codebook into multiple groups, and a second part indicating a first codepoint of the first HARQ-ACK codebook and a second codepoint of the second HARQ-ACK codebook based on the group within the third compression data set that is indicated in the first part.
Aspect 5 is the method of any of aspects 1 to 4, wherein the at least one processor, individually or in any combination, is further configured to: receive, from the network node, a first configuration indicative of at least one of the first compression data set, the second compression data set, or the third compression data set.
Aspect 6 is the method of any of aspects 1 to 5, wherein at least one of the first compression data set, the second compression data set, or the third compression data set is a partitioned data set that includes a first number of N-bit codepoint values, wherein each of the first number of N-bit codepoint values is associated with a respective first part and a respective second part, and wherein N is a positive integer.
Aspect 7 is the method of any of aspects 1 to 6, wherein the one or more downlink transmissions include a first physical downlink shared channel (PDSCH) associated with the first HARQ-ACK codebook that is associated with a first error probability or rate and a second PDSCH associated with the second HARQ-ACK codebook that is associated with a second error probability or rate; or wherein the apparatus comprises a transceiver coupled to the at least one processor, wherein to receive the one or more downlink transmissions from the network node, the at least one processor, individually or in any combination, is configured to receive, from the network node and another network node via the transceiver, the one or more downlink transmissions, wherein the one or more downlink transmissions include the first PDSCH associated with the first HARQ-ACK codebook and the second PDSCH associated with the second HARQ-ACK codebook.
Aspect 8 is the method of aspect 1, wherein the two-part HARQ-ACK feedback includes separate compressions of first HARQ-ACK feedback based on the first compression data set and the first HARQ-ACK codebook and second HARQ-ACK feedback based on the second compression data set and the second HARQ-ACK codebook.
Aspect 9 is the method of aspect 8, wherein the at least one processor, individually or in any combination, is further configured to: encode, as a payload for the two-part HARQ-ACK feedback and for an associated channel, at least one of a first part of a first compressed codebook, the first part of a second compressed codebook, a second part of the first compressed codebook, or the second part of the second compressed codebook.
Aspect 10 is the method of aspect 9, wherein the separate compressions based on the first HARQ-ACK codebook and the second HARQ-ACK codebook includes: a concatenation of (i) the first part of the first compressed codebook with the first part of the second compressed codebook and (ii) the second part of the first compressed codebook and the second part of the second compressed codebook; wherein encoding includes encoding together (i) the concatenated first part of the first compressed codebook and the first part of the second compressed codebook and (ii) the concatenated second part of the first compressed codebook and the second part of the second compressed codebook; wherein the payload of the two-part HARQ-ACK feedback is included in a physical uplink shared channel (PUSCH) transmission or a physical uplink control channel (PUCCH) transmission that are multiplexed.
Aspect 11 is the method of aspect 9, wherein to encode, the at least one processor, individually or in any combination, is configured to separately encode each of the first part of the first compressed codebook, the first part of the second compressed codebook, the second part of the first compressed codebook, and the second part of the second compressed codebook.
Aspect 12 is the method of aspect 9, wherein to encode, the at least one processor, individually or in any combination, is configured to encode by at least one of: separately encoding the first part of the first compressed codebook and the first part of the second compressed codebook, wherein one of the first part of the first compressed codebook and the first part of the second compressed codebook has a high priority and another has a low priority, and jointly encoding the second part of the first compressed codebook and the second part of the second compressed codebook, wherein one of the second part of the first compressed codebook and the second part of the second compressed codebook has the high priority and another has the low priority; jointly encoding the first part of the first compressed codebook and the first part of the second compressed codebook, wherein one of the first part of the first compressed codebook and the first part of the second compressed codebook has the high priority and another has the low priority, and separately encoding the second part of the first compressed codebook and the second part of the second compressed codebook, wherein one of the second part of the first compressed codebook and the second part of the second compressed codebook has the high priority and another has the low priority; or separately encoding each of the first part of the first compressed codebook, the first part of the second compressed codebook, the second part of the first compressed codebook, and the second part of the second compressed codebook, and dropping the second part of the second compressed codebook based on the second part of the first compressed codebook having the high priority and the second part of the second compressed codebook having the low priority.
Aspect 13 is the method of aspect 1, wherein the two-part HARQ-ACK feedback comprises a joint compression associated with the third compression data set that partitions the combination of the first HARQ-ACK codebook and the second HARQ-ACK codebook.
Aspect 14 is the method of aspect 13, wherein the at least one processor, individually or in any combination, is further configured to: encode, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set.
Aspect 15 is the method of aspect 14, wherein the payload of the two-part HARQ-ACK feedback is included in a physical uplink shared channel (PUSCH) transmission or a physical uplink control channel (PUCCH) transmission that are multiplexed.
Aspect 16 is the method of aspect 13, wherein the first parts and the second parts, which are based on the third compression data set, are associated with products of probabilities from the first compression data set and the second compression data set, wherein the probabilities correspond to code point values in the first compression data set and the second compression data set.
Aspect 17 is the method of any of aspects 1 to 16, wherein the first compression data set is associated with transport block (TB) based feedback, and the second compression data set is associated with code block group (CBG) based feedback; or wherein the first compression data set is associated with a higher priority HARQ-ACK feedback, and the second compression data set is associated with a lower priority HARQ-ACK feedback.
Aspect 18 is a method of wireless communication at a network node, comprising: configuring a user equipment (UE) with at least one of (i) a first configuration indicative of at least one of a first compression data set, a second compression data set, or a third compression data set; and receiving, from the UE, two-part hybrid automatic repeat request (HARQ) acknowledgement (HARQ-ACK) feedback for one or more downlink transmissions based on at least one of: the first compression data set for a first HARQ-ACK codebook and the second compression data set based on a second HARQ-ACK codebook, or the third compression data set based on a combination of the first HARQ-ACK codebook and the second HARQ-ACK codebook.
Aspect 19 is the method of aspect 18, wherein the at least one processor, individually or in any combination, is further configured to: decode a payload of the two-part HARQ-ACK feedback based on the first configuration.
Aspect 20 is the method of aspect 18, wherein at least one of the first compression data set, the second compression data set, or the third compression data set is a partitioned data set that includes a first number of N-bit codepoint values, wherein each of the first number of N-bit codepoint values is associated with a respective first part and a respective second part, and wherein N is a positive integer.
Aspect 21 is the method of any of aspects 18 to 20, wherein a first compressed codebook, associated with a first HARQ-ACK codebook, and a second compressed codebook, associated with a second HARQ-ACK codebook, are based on at least one of: a separate compression of (i) a first part of the first HARQ-ACK codebook for the first compression data set and a second part of the first HARQ-ACK codebook for the first compression data set, and (ii) a first part of the second HARQ-ACK codebook for the first compression data set and a second part of the second HARQ-ACK codebook for the second compression data set, or a joint compression of (i) first parts of both the first HARQ-ACK codebook and the second HARQ-ACK codebook for the third compression data set, and (ii) second parts of both the first HARQ-ACK codebook and the second HARQ-ACK codebook.
Aspect 22 is the method of aspect 21, wherein the first compressed codebook and the second compressed codebook are based on the separate compression; wherein the separate compression is associated with an encoding, for an associated channel, of at least one of the first part of the first compressed codebook, the first part of the second compressed codebook, the second part of the first compressed codebook, or the second part of the second compressed codebook.
Aspect 23 is the method of aspect 22, wherein the encoding includes a first encoding of the first part of the first compressed codebook and the first part of the second compressed codebook, and a second encoding of the second part of the first compressed codebook and the second part of the second compressed codebook.
Aspect 24 is the method of aspect 23, wherein the separate compression is based on a concatenation of (i) the first part of the first compressed codebook with the first part of the second compressed codebook and (ii) the second part of the first compressed codebook and the second part of the second compressed codebook, wherein the first encoding includes a concatenated first part of the first compressed codebook and first part of the second compressed codebook, and the second encoding includes a concatenated second part of the first compressed codebook and second part of the second compressed codebook, wherein a payload of the two-part HARQ-ACK feedback is included in a physical uplink shared channel (PUSCH) transmission or a physical uplink control channel (PUCCH) transmission that are multiplexed; or wherein the encoding includes a separate encoding of each of the first part of the first compressed codebook, the first part of the second compressed codebook, the second part of the first compressed codebook, and the second part of the second compressed codebook.
Aspect 25 is the method of aspect 21, wherein the first compressed codebook and the second compressed codebook are based on the joint compression; wherein the joint compression is associated with an encoding, for an associated channel, of the first parts of both the first compressed codebook and the second compressed codebook, and the second parts of both the first HARQ-ACK codebook that is associated with a first error probability or rate and the second HARQ-ACK codebook that is associated with a second error probability or rate.
Aspect 26 is the method of aspect 25, wherein a payload of the two-part HARQ-ACK feedback is included in a physical uplink shared channel (PUSCH) transmission or a physical uplink control channel (PUCCH) transmission that are multiplexed; or wherein the first parts and the second parts based on the third compression data set are associated with products of probabilities from the first compression data set and the second compression data set, wherein the probabilities correspond to code point values in the first compression data set and the second compression data set.
Aspect 27 is the method of aspect 21, wherein at least one of the separate compression or the joint compression is associated with an encoding, wherein the encoding is based on at least one of: a separate encoding of the first part of the first compressed codebook and the first part of the second compressed codebook, wherein one of the first part of the first compressed codebook and the first part of the second compressed codebook has a high priority and another has a low priority, and a joint encoding of the second part of the first compressed codebook and the second part of the second compressed codebook, wherein one of the second part of the first compressed codebook and the second part of the second compressed codebook has the high priority and another has the low priority; a joint encoding of the first part of the first compressed codebook and the first part of the second compressed codebook, wherein one of the first part of the first compressed codebook and the first part of the second compressed codebook has the high priority and another has the low priority, and a separate encoding of the second part of the first compressed codebook and the second part of the second compressed codebook, wherein one of the second part of the first compressed codebook and the second part of the second compressed codebook has the high priority and another has the low priority; or a separately encoding of each of the first part of the first compressed codebook, the first part of the second compressed codebook, the second part of the first compressed codebook, and the second part of the second compressed codebook, wherein the second part of the second compressed codebook is dropped based on the second part of the first compressed codebook having the high priority and the second part of the second compressed codebook having the low priority.
Aspect 28 is the method of any of aspects 18 to 27, wherein the first compression data set is associated with transport block (TB) based feedback, and the second compression data set is associated with code block group (CBG) based feedback; or wherein the first compression data set is associated with a higher priority HARQ-ACK feedback, and the second compression data set is associated with a lower priority HARQ-ACK feedback.
Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 17.
Aspect 30 is an apparatus for wireless communication at a user equipment (UE), comprising means for performing each step in the method of any of aspects 1 to 17.
Aspect 31 is the apparatus of any of aspects 1 to 17, further comprising a transceiver configured to receive or to transmit in association with the method of any of aspects 1 to 17.
Aspect 32 is a computer-readable medium (e.g., a non-transitory computer-readable medium) storing computer executable code a user equipment (UE), the code when executed by at least one processor causes the UE to perform the method of any of aspects 18 to 28.
Aspect 33 is an apparatus for wireless communication at a user equipment (UE), comprising: at least one memory; and at least one processor coupled to the at least one memory, the at least one processor, individually or in any combination, is configured to perform the method of any of aspects 18 to 28.
Aspect 34 is an apparatus for wireless communication at a user equipment (UE), comprising means for performing each step in the method of any of aspects 18 to 28.
Aspect 35 is the apparatus of any of aspects 18 to 28, further comprising a transceiver configured to receive or to transmit in association with the method of any of aspects 18 to 28.
Aspect 36 is a computer-readable medium (e.g., a non-transitory computer-readable medium) storing computer executable code a user equipment (UE), the code when executed by at least one processor causes the UE to perform the method of any of aspects 18 to 28.

What is claimed is:

1. An apparatus for wireless communication at a user equipment (UE), comprising:
memory; and
at least one processor coupled to the memory and, based at least in part on information stored in the memory, the at least one processor, individually or in any combination, is configured to:
receive one or more downlink transmissions from a network node; and
transmit two-part hybrid automatic repeat request (HARQ) acknowledgement (HARQ-ACK) feedback for the one or more downlink transmissions based on at least one of:
a first compression data set for a first codebook and a second compression data set for a second HARQ-ACK codebook, or
a third compression data set based on a combination of the first HARQ-ACK codebook and the second HARQ-ACK codebook.

2. The apparatus of claim 1, wherein the two-part HARQ-ACK feedback includes:
a first part indicating a first group within the first compression data set that partitions the first HARQ-ACK codebook into a first set of multiple groups and a second part indicating a first codepoint of the first HARQ-ACK codebook within the first group indicated in the first part, and
a third part indicating a second group within the second compression data set that partitions the second HARQ-ACK codebook into a second set of multiple groups and a fourth part indicating a second codepoint of the second HARQ-ACK codebook within the second group indicated in the third part.

3. The apparatus of claim 1, wherein the two-part HARQ-ACK feedback includes jointly compressed feedback based on the third compression data set.

4. The apparatus of claim 3, wherein the two-part HARQ-ACK feedback includes:
a first part indicating a group within the third compression data set that partitions the combination of the first HARQ-ACK codebook and the second HARQ-ACK codebook into multiple groups, and
a second part indicating a first codepoint of the first HARQ-ACK codebook and a second codepoint of the second HARQ-ACK codebook based on the group within the third compression data set that is indicated in the first part.

5. The apparatus of claim 1, wherein the at least one processor, individually or in any combination, is further configured to:
receive, from the network node, a first configuration indicative of at least one of the first compression data set, the second compression data set, or the third compression data set.

6. The apparatus of claim 1, wherein at least one of the first compression data set, the second compression data set, or the third compression data set is a partitioned data set that includes a first number of N-bit codepoint values, wherein each of the first number of N-bit codepoint values is associated with a respective first part and a respective second part, and wherein N is a positive integer.

7. The apparatus of claim 1, wherein the one or more downlink transmissions include a first physical downlink shared channel (PDSCH) associated with the first HARQ-ACK codebook that is associated with a first error probability or rate and a second PDSCH associated with the second HARQ-ACK codebook that is associated with a second error probability or rate; or
wherein the apparatus comprises a transceiver coupled to the at least one processor, wherein to receive the one or more downlink transmissions from the network node, the at least one processor, individually or in any combination, is configured to receive, from the network node and another network node via the transceiver, the one or more downlink transmissions, wherein the one or more downlink transmissions include the first PDSCH associated with the first HARQ-ACK codebook and the second PDSCH associated with the second HARQ-ACK codebook.

8. The apparatus of claim 1, wherein the two-part HARQ-ACK feedback includes separate compressions of first HARQ-ACK feedback based on the first compression data set and the first HARQ-ACK codebook and second HARQ-ACK feedback based on the second compression data set and the second HARQ-ACK codebook.

9. The apparatus of claim 8, wherein the at least one processor, individually or in any combination, is further configured to:
encode, as a payload for the two-part HARQ-ACK feedback and for an associated channel, at least one of a first part of a first compressed codebook, the first part of a second compressed codebook, a second part of the first compressed codebook, or the second part of the second compressed codebook.

10. The apparatus of claim 9, wherein the separate compressions based on the first HARQ-ACK codebook and the second HARQ-ACK codebook includes:
a concatenation of (i) the first part of the first compressed codebook with the first part of the second compressed codebook and (ii) the second part of the first compressed codebook and the second part of the second compressed codebook;
wherein encoding includes encoding together (i) the concatenated first part of the first compressed codebook and the first part of the second compressed codebook and (ii) the concatenated second part of the first compressed codebook and the second part of the second compressed codebook;
wherein the payload of the two-part HARQ-ACK feedback is included in a physical uplink shared channel (PUSCH) transmission or a physical uplink control channel (PUCCH) transmission that are multiplexed.

11. The apparatus of claim 9, wherein to encode, the at least one processor, individually or in any combination, is configured to separately encode each of the first part of the first compressed codebook, the first part of the second compressed codebook, the second part of the first compressed codebook, and the second part of the second compressed codebook.

12. The apparatus of claim 9, wherein to encode, the at least one processor, individually or in any combination, is configured to encode by at least one of:
separately encoding the first part of the first compressed codebook and the first part of the second compressed codebook, wherein one of the first part of the first compressed codebook and the first part of the second compressed codebook has a high priority and another has a low priority, and jointly encoding the second part of the first compressed codebook and the second part of the second compressed codebook, wherein one of the second part of the first compressed codebook and the second part of the second compressed codebook has the high priority and another has the low priority;
jointly encoding the first part of the first compressed codebook and the first part of the second compressed codebook, wherein one of the first part of the first compressed codebook and the first part of the second compressed codebook has the high priority and another has the low priority, and separately encoding the second part of the first compressed codebook and the second part of the second compressed codebook, wherein one of the second part of the first compressed codebook and the second part of the second compressed codebook has the high priority and another has the low priority; or
separately encoding each of the first part of the first compressed codebook, the first part of the second compressed codebook, the second part of the first compressed codebook, and the second part of the second compressed codebook, and dropping the second part of the second compressed codebook based on the second part of the first compressed codebook having the high priority and the second part of the second compressed codebook having the low priority.

13. The apparatus of claim 1, wherein the two-part HARQ-ACK feedback comprises a joint compression associated with the third compression data set that partitions the combination of the first HARQ-ACK codebook and the second HARQ-ACK codebook.

14. The apparatus of claim 13, wherein the at least one processor, individually or in any combination, is further configured to:
encode, as a payload for the two-part HARQ-ACK feedback and for an associated channel, first parts of both a first compressed codebook and a second compressed codebook based on the third compression data set, and second parts of both the first HARQ-ACK codebook and the second HARQ-ACK codebook based on the third compression data set.

15. The apparatus of claim 14, wherein the payload of the two-part HARQ-ACK feedback is included in a physical uplink shared channel (PUSCH) transmission or a physical uplink control channel (PUCCH) transmission that are multiplexed.

16. The apparatus of claim 13, wherein the first parts and the second parts, which are based on the third compression data set, are associated with products of probabilities from the first compression data set and the second compression data set, wherein the probabilities correspond to code point values in the first compression data set and the second compression data set.

17. The apparatus of claim 1, wherein the first compression data set is associated with transport block (TB) based feedback, and the second compression data set is associated with code block group (CBG) based feedback; or
wherein the first compression data set is associated with a higher priority HARQ-ACK feedback, and the second compression data set is associated with a lower priority HARQ-ACK feedback.

18. An apparatus for wireless communication at a network node, comprising:
memory; and
at least one processor coupled to the memory and, based at least in part on information stored in the memory, the at least one processor, individually or in any combination, is configured to:
configure a user equipment (UE) with at least one of (i) a first configuration indicative of at least one of a first compression data set, a second compression data set, or a third compression data set; and
receive, from the UE, two-part hybrid automatic repeat request (HARQ) acknowledgement (HARQ-ACK) feedback for one or more downlink transmissions based on at least one of:
the first compression data set for a first HARQ-ACK codebook and the second compression data set based on a second HARQ-ACK codebook, or
the third compression data set based on a combination of the first HARQ-ACK codebook and the second HARQ-ACK codebook.

19. The apparatus of claim 18, wherein the at least one processor, individually or in any combination, is further configured to:
decode a payload of the two-part HARQ-ACK feedback based on the first configuration.

20. The apparatus of claim 18, wherein at least one of the first compression data set, the second compression data set, or the third compression data set is a partitioned data set that includes a first number of N-bit codepoint values, wherein each of the first number of N-bit codepoint values is associated with a respective first part and a respective second part, and wherein N is a positive integer.

21. The apparatus of claim 18, wherein a first compressed codebook, associated with a first HARQ-ACK codebook, and a second compressed codebook, associated with a second HARQ-ACK codebook, are based on at least one of:
a separate compression of (i) a first part of the first HARQ-ACK codebook for the first compression data set and a second part of the first HARQ-ACK codebook for the first compression data set, and (ii) a first part of the second HARQ-ACK codebook for the first compression data set and a second part of the second HARQ-ACK codebook for the second compression data set, or
a joint compression of (i) first parts of both the first HARQ-ACK codebook and the second HARQ-ACK codebook for the third compression data set, and (ii) second parts of both the first HARQ-ACK codebook and the second HARQ-ACK codebook.

22. The apparatus of claim 21, wherein the first compressed codebook and the second compressed codebook are based on the separate compression;
wherein the separate compression is associated with an encoding, for an associated channel, of at least one of the first part of the first compressed codebook, the first part of the second compressed codebook, the second part of the first compressed codebook, or the second part of the second compressed codebook.

23. The apparatus of claim 22, wherein the encoding includes a first encoding of the first part of the first compressed codebook and the first part of the second compressed codebook, and a second encoding of the second part of the first compressed codebook and the second part of the second compressed codebook.

24. The apparatus of claim 23, wherein the separate compression is based on a concatenation of (i) the first part of the first compressed codebook with the first part of the second compressed codebook and (ii) the second part of the first compressed codebook and the second part of the second compressed codebook,
wherein the first encoding includes a concatenated first part of the first compressed codebook and first part of the second compressed codebook, and the second encoding includes a concatenated second part of the first compressed codebook and second part of the second compressed codebook,
wherein a payload of the two-part HARQ-ACK feedback is included in a physical uplink shared channel (PUSCH) transmission or a physical uplink control channel (PUCCH) transmission that are multiplexed; or
wherein the encoding includes a separate encoding of each of the first part of the first compressed codebook, the first part of the second compressed codebook, the second part of the first compressed codebook, and the second part of the second compressed codebook.

25. The apparatus of claim 21, wherein the first compressed codebook and the second compressed codebook are based on the joint compression;
wherein the joint compression is associated with an encoding, for an associated channel, of the first parts of both the first compressed codebook and the second compressed codebook, and the second parts of both the first HARQ-ACK codebook that is associated with a first error probability or rate and the second HARQ-ACK codebook that is associated with a second error probability or rate.

26. The apparatus of claim 25, wherein a payload of the two-part HARQ-ACK feedback is included in a physical uplink shared channel (PUSCH) transmission or a physical uplink control channel (PUCCH) transmission that are multiplexed; or
wherein the first parts and the second parts based on the third compression data set are associated with products of probabilities from the first compression data set and the second compression data set, wherein the probabilities correspond to code point values in the first compression data set and the second compression data set.

27. The apparatus of claim 21, wherein at least one of the separate compression or the joint compression is associated with an encoding, wherein the encoding is based on at least one of:
a separate encoding of the first part of the first compressed codebook and the first part of the second compressed codebook, wherein one of the first part of the first compressed codebook and the first part of the second compressed codebook has a high priority and another has a low priority, and a joint encoding of the second part of the first compressed codebook and the second part of the second compressed codebook, wherein one of the second part of the first compressed codebook and the second part of the second compressed codebook has the high priority and another has the low priority;
a joint encoding of the first part of the first compressed codebook and the first part of the second compressed codebook, wherein one of the first part of the first compressed codebook and the first part of the second compressed codebook has the high priority and another has the low priority, and a separate encoding of the second part of the first compressed codebook and the second part of the second compressed codebook, wherein one of the second part of the first compressed codebook and the second part of the second compressed codebook has the high priority and another has the low priority; or
a separately encoding of each of the first part of the first compressed codebook, the first part of the second compressed codebook, the second part of the first compressed codebook, and the second part of the second compressed codebook, wherein the second part of the second compressed codebook is dropped based on the second part of the first compressed codebook having the high priority and the second part of the second compressed codebook having the low priority.

28. The apparatus of claim 18, wherein the first compression data set is associated with transport block (TB) based feedback, and the second compression data set is associated with code block group (CBG) based feedback; or
wherein the first compression data set is associated with a higher priority HARQ-ACK feedback, and the second compression data set is associated with a lower priority HARQ-ACK feedback.

29. A method of wireless communications at a user equipment (UE), comprising:
receiving one or more downlink transmissions from a network node; and
transmitting two-part hybrid automatic repeat request (HARQ) acknowledgement (HARQ-ACK) feedback for the one or more downlink transmissions based on at least one of:
a first compression data set for a first HARQ-ACK codebook and a second compression data set for a second HARQ-ACK codebook, or
a third compression data set based on a combination of the first HARQ-ACK codebook and the second HARQ-ACK codebook.

30. A method of wireless communications at a network node, comprising:
configuring a user equipment (UE) with at least one of (i) a first configuration indicative of at least one of a first compression data set, a second compression data set, or a third compression data set; and
receiving, from the UE, two-part hybrid automatic repeat request (HARQ) acknowledgement (HARQ-ACK) feedback for one or more downlink transmissions based on at least one of:
the first compression data set for a first HARQ-ACK codebook and the second compression data set based on a second HARQ-ACK codebook, or
the third compression data set based on a combination of the first HARQ-ACK codebook and the second HARQ-ACK codebook.
